(19) United States
(12) Patent Application Publication
(10) Pub. No.: US 2013/0085855 A1
(43) Pub. Date: Apr. 4, 2013

(54) GESTURE BASED NAVIGATION SYSTEM

(71) Applicants: Matthew G. Dyor, Bellevue, WA (US); Royce A. Levien, Lexington, MA (US); Richard T. Lord, Tacoma, WA (US); Robert W. Lord, Seattle, WA (US); Mark A. Malamud, Seattle, WA (US); Xuedong Huang, Bellevue, WA (US); Marc E. Davis, San Francisco, CA (US)

(72) Inventors: Matthew G. Dyor, Bellevue, WA (US); Royce A. Levien, Lexington, MA (US); Richard T. Lord, Tacoma, WA (US); Robert W. Lord, Seattle, WA (US); Mark A. Malamud, Seattle, WA (US); Xuedong Huang, Bellevue, WA (US); Marc E. Davis, San Francisco, CA (US)

(21) Appl. No.: 13/284,688

(22) Filed: Oct. 28, 2011

Related U.S. Application Data
(63) Continuation-in-part of application No. 13/251,046, filed on Sep. 30, 2011.
Application No. 13/251,046 is a continuation-in-part of application No. 13/269,466, filed on Oct. 7, 2011.
Application No. 13/269,466 is a continuation-in-part of application No. 13/278,680, filed on Oct. 21, 2011.
Application No. 13/278,680 is a continuation-in-part of application No. 13/284,673, filed on Oct. 28, 2011.

(51) Int. Cl. G06F 3/01; G06F 3/048; G06Q 30/06; G06F 17/00; G06Q 30/02; G06F 3/033; G06F 3/16

(52) U.S. Cl. 705/14.55; 715/863; 715/810; 715/790; 715/781; 715/728; 715/702; 715/234; 705/26.1

(57) ABSTRACT

Methods, systems, and techniques for automatically providing auxiliary content are provided. Example embodiments provide a Gesture Based Navigation System (GBNS), which enables a gesture-based user interface to navigate to auxiliary content that is related to an portion of electronic input that has been indicated by a received gesture. In overview, the GBNS allows a portion (e.g., an area, part, or the like) of electronically presented content to be dynamically indicated by a gesture. The GBNS then examines the indicated portion in conjunction with a set of (e.g., one or more) factors to determine auxiliary content to navigate to. Auxiliary content may be in many forms, including, for example, a web page, code, document, or the like. Once the auxiliary content is determined, it is then presented to the user, for example, using a separate panel, an overlay, or in any other fashion.

### CROSS-REFERENCE TO RELATED APPLICATIONS

The present application is related to and claims the benefit of the earliest available effective filing date(s) from the following listed application(s) (the “Related Applications”) (e.g., claims earliest available priority dates for other than provisional patent applications or claims benefits under 35 USC §119(e) for provisional patent applications, for any and all parent, grandparent, great-grandparent, etc. applications of the Related Application(s)). All subject matter of the Related Applications and of any and all parent, grandparent, great-grandparent, etc. applications of the Related Applications is incorporated herein by reference to the extent such subject matter is not inconsistent herewith.

### RELATED APPLICATIONS

For purposes of the USPTO extra-statutory requirements, the present application constitutes a continuation-in-part of U.S. patent application Ser. No. 13/251,046, entitled GESTURELET BASED NAVIGATION TO AUXILIARY CONTENT, naming Matthew Dyor, Royce Levien, Richard T. Lord, Robert W. Lord, Mark Malamud as inventors, filed 30 Sep. 2011, which is currently co-pending, or is an application of which a currently co-pending application is entitled to the benefit of the filing date.

For purposes of the USPTO extra-statutory requirements, the present application constitutes a continuation-in-part of U.S. patent application Ser. No. 13/269,466, entitled PERSISTENT GESTURELETS, naming Matthew Dyor, Royce Levien, Richard T. Lord, Robert W. Lord, Mark Malamud as inventors, filed 7 Oct. 2011, which is currently co-pending, or is an application of which a currently co-pending application is entitled to the benefit of the filing date.

For purposes of the USPTO extra-statutory requirements, the present application constitutes a continuation-in-part of U.S. patent application Ser. No. 13/278,680, entitled GESTURE BASED CONTEXT MENUS, naming Matthew Dyor, Royce Levien, Richard T. Lord, Robert W. Lord, Mark Malamud as inventors, filed 21 Oct. 2011, which is currently co-pending, or is an application of which a currently co-pending application is entitled to the benefit of the filing date.

For purposes of the USPTO extra-statutory requirements, the present application constitutes a continuation-in-part of U.S. patent application Ser. No. 13/284,673, entitled GESTURE BASED SEARCH SYSTEM, naming Matthew Dyor, Royce Levien, Richard T. Lord, Robert W. Lord, Mark Malamud as inventors, filed 28 Oct. 2011, which is currently co-pending, or is an application of which a currently co-pending application is entitled to the benefit of the filing date.

### TECHNICAL FIELD

The present disclosure relates to methods, techniques, and systems for providing a gesture-based search system and, in particular, to methods, techniques, and systems for automatically initiating a search based upon gestured input.

### BACKGROUND

As massive amounts of information continue to become progressively more available to users connected via a network, such as the Internet, a company intranet, or a proprietary network, it is becoming increasingly more difficult for a user to find particular information that is relevant, such as for a task, information discovery, or for some other purpose. Typically, a user invokes one or more search engines and provides them with keywords that are meant to cause the search engine to return results that are relevant because they contain the same or similar keywords to the ones submitted by the user. Often, the user iterates using this process until he or she believes that the results returned are sufficiently close to what is desired. The better the user understands or knows what he or she is looking for, often the more relevant the results. Thus, such tools can often be frustrating when employed for information discovery where the user may or may not know much about the topic at hand.

Different search engines and search technology have been developed to increase the precision and correctness of search results returned, including arming such tools with the ability to add useful additional search terms (e.g., synonyms), rephrase queries, and take into account document related information such as whether a user-specified keyword appears in a particular position in a document. In addition, search engines that utilize natural language processing capabilities have been developed.

In addition, it has becoming increasingly more difficult for a user to navigate the information and remember what information was visited, even if the user knows what he or she is looking for. Although bookmarks available in some client applications (such as a web browser) provide an easy way for a user to return to a known location (e.g., web page), they do not provide a dynamic memory that assists a user from going from one display or document to another, and then to another. Some applications provide “hyperlinks,” which are cross-references to other information, typically a document or a portion of a document. These hyperlink cross-references are typically selectable, and when selected by a user (such as by using an input device such as a mouse, pointer, pen device, etc.), result in the other information being displayed to the user. For example, a user running a web browser that communicates via the World Wide Web network may select a hyperlink displayed on a web page to navigate to another page encoded by the hyperlink. Hyperlinks are typically placed into a document by the document author or creator, and, in any case, are embedded into the electronic representation of the document. When the location of the other information changes, the hyperlink is “broken” until it is updated and/or replaced. In some systems, users can also create such links in a document, which are then stored as part of the document representation.

Even with advancements, searching and navigating the morass of information is oft times still a frustrating user experience.

### BRIEF DESCRIPTION OF THE DRAWINGS

FIG. 1A is a screen display of example gesture based input performed by an example Gesture Based Navigation System (GBNS) or process.

FIG. 1B is a screen display of an example gesture based auxiliary content determined by an example Gesture Based Navigation System or process.

FIG. 1C is a screen display of an example gesture based auxiliary content determined by an example Gesture Based Navigation System or process.

FIG. 1D is a block diagram of an example environment for determining and navigating to auxiliary content using an example Gesture Based Navigation System (GBNS) or process.

FIG. 2A is an example block diagram of components of an example Gesture Based Navigation System.

FIG. 2B is an example block diagram of further components of the Input Module of an example Gesture Based Navigation System.

FIG. 2C is an example block diagram of further components of the Factor Determination Module of an example Gesture Based Navigation System.

FIG. 2D is an example block diagram of further components of the Context Menu Handling Module of an example Gesture Based Navigation System.

FIG. 2E is an example block diagram of further components of the Auxiliary Content Determination Module of an example Gesture Based Navigation System.

FIG. 2F is an example block diagram of further components of the Presentation Module of an example Gesture Based Navigation System.

FIG. 3 is an example flow diagram of example logic for providing gesture based navigation to auxiliary content.

FIG. 4 is an example flow diagram of example logic illustrating various example embodiments of block 304 of FIG. 3.

FIG. 5 is an example flow diagram of example logic illustrating various example embodiments of block 304 of FIG. 3.

FIG. 6 is an example flow diagram of example logic illustrating various example embodiments of block 304 of FIG. 3.

FIG. 7 is an example flow diagram of example logic illustrating various example embodiments of block 304 of FIG. 3.

FIG. 8A is an example flow diagram of example logic illustrating various example embodiments of block 304 of FIG. 3.

FIG. 8B is an example flow diagram of example logic illustrating various example embodiments of block 304 of FIG. 3.

FIG. 8C is an example flow diagram of example logic illustrating various example embodiments of block 304 of FIG. 3.

FIG. 8D is an example flow diagram of example logic illustrating various example embodiments of block 304 of FIG. 3.

FIG. 8E is an example flow diagram of example logic illustrating various example embodiments of block 825 of FIG. 8C.

FIG. 9 is an example flow diagram of example logic illustrating various example embodiments of block 304 of FIG. 3.

FIG. 10 is an example flow diagram of example logic illustrating various example embodiments of block 304 of FIG. 3.

FIG. 11A is an example flow diagram of example logic illustrating various example embodiments of block 306 of FIG. 3.

FIG. 11B is an example flow diagram of example logic illustrating various example embodiments of block 306 of FIG. 3.

FIG. 11C is an example flow diagram of example logic illustrating various example embodiments of block 1108 of FIG. 11B.

FIG. 12 is an example flow diagram of example logic illustrating various example embodiments of block 308 of FIG. 3.

FIG. 13A is an example flow diagram of example logic illustrating various example embodiments of block 302 of FIG. 3.

FIG. 13B is an example flow diagram of example logic illustrating various example embodiments of block 302 of FIG. 3.

FIG. 13C is an example flow diagram of example logic illustrating various example embodiments of block 302 of FIG. 3.

FIG. 14 is an example flow diagram of example logic illustrating various example embodiments of blocks 302-308 of FIG. 3.

FIG. 15 is an example block diagram of a computing system for practicing embodiments of a Gesture Based Navigation System.

### DETAILED DESCRIPTION

Embodiments described herein provide enhanced computer- and network-based methods, techniques, and systems for automatically navigating to auxiliary content in a gesture based input system. Example embodiments provide a Gesture Based Navigation System (GBNS), which enables a gesture-based user interface to determine (e.g., find, locate, generate, designate, define or cause to be found, located, generated, designated, defined, or the like) auxiliary content related to an portion of electronic input that has been indicated by a received gesture and to navigate to (e.g., present) such content.

In overview, the GBNS allows a portion (e.g., an area, part, or the like) of electronically presented content to be dynamically indicated by a gesture. The gesture may be provided in the form of some type of pointer, for example, a mouse, a touch sensitive display, a wireless device, a human body part, a microphone, a stylus, and/or a pointer that indicates a word, phrase, icon, image, or video, or may be provided in audio form. The GBNS then examines the indicated portion in conjunction with a set of (e.g., one or more) factors to determine some auxiliary content that is, typically, related to the indicated portion and/or the factors. The GBNS then automatically navigates to the auxiliary content by presented the content on a presentation screen and/or by shifting the user's focus somehow to the auxiliary content. For example, if the GBNS determines that an advertisement is appropriate to navigate to, then the advertisement may be presented to the user (textually, visually, and/or via audio) instead of or in conjunction with the already presented content.

The determination of the auxiliary content is based upon content contained in the portion of the presented electronic indicated by the gestured input as well as possibly one or more of a set of factors. Content may include, for example, a word, phrase, spoken utterance, image, video, pattern, and/or other audio signal. Also, the portion may be formed from contiguous or composed of separate non-contiguous parts, for example, a title with a disconnected sentence. In addition, the indicated portion may represent the entire body of electronic content presented to the user. For the purposes described herein, the electronic content may comprise any type of content that can be presented for gestured input, including, for example, text, a document, music, a video, an image, a sound, or the like.

As stated, the GBNS may incorporate information from a set of factors (e.g., criteria, state, influencers, things, features, and the like) in addition to the content contained in the indicated portion. The set of factors that may influence what auxiliary content is determined to be appropriate may include such things as context surrounding or otherwise relating to the indicated portion (as indicated by the gesture), such as other text, audio, graphics, and/or objects within the presented electronic content; some attribute of the gesture itself, such as size, direction, color, how the gesture is steered (e.g., smudged, nudged, adjusted, and the like); presentation device capabilities, for example, the size of the presentation device, whether text or audio is being presented; prior device communication history, such as what other devices have recently been used by this user or to which other devices the user has been connected; time of day; and/or prior history associated with the user, such as prior search history, navigation history, purchase history, and/or demographic information (e.g., age, gender, location, contact information, or the like). In addition, information from a context menu, such as a selection of a menu item by the user, may be used to assist the GBNS in determining auxiliary content.

Once the auxiliary content is determined, the GBNS automatically causes navigation to the determined auxiliary content. The auxiliary content is “auxiliary” content in that it is additional, supplemental or somehow related to what is currently presented to the user as the presented electronic content. The auxiliary content may be anything, including, for example, a web page, computer code, electronic document, electronic version of a paper document, a purchase or an offer to purchase a product or service, social networking content, and/or the like.

This auxiliary content is the presented to the user in conjunction with the presented electronic content, for example, by use of an overlay; in a separate presentation element (e.g., window, pane, frame, or other construct) such as a window juxtaposed (e.g., next to, contiguous with, nearly up against) to the presented electronic content; and/or, as an animation, for example, a pane that slides in to partially or totally obscure the presented electronic content. Other methods of presenting the auxiliary content are contemplated.

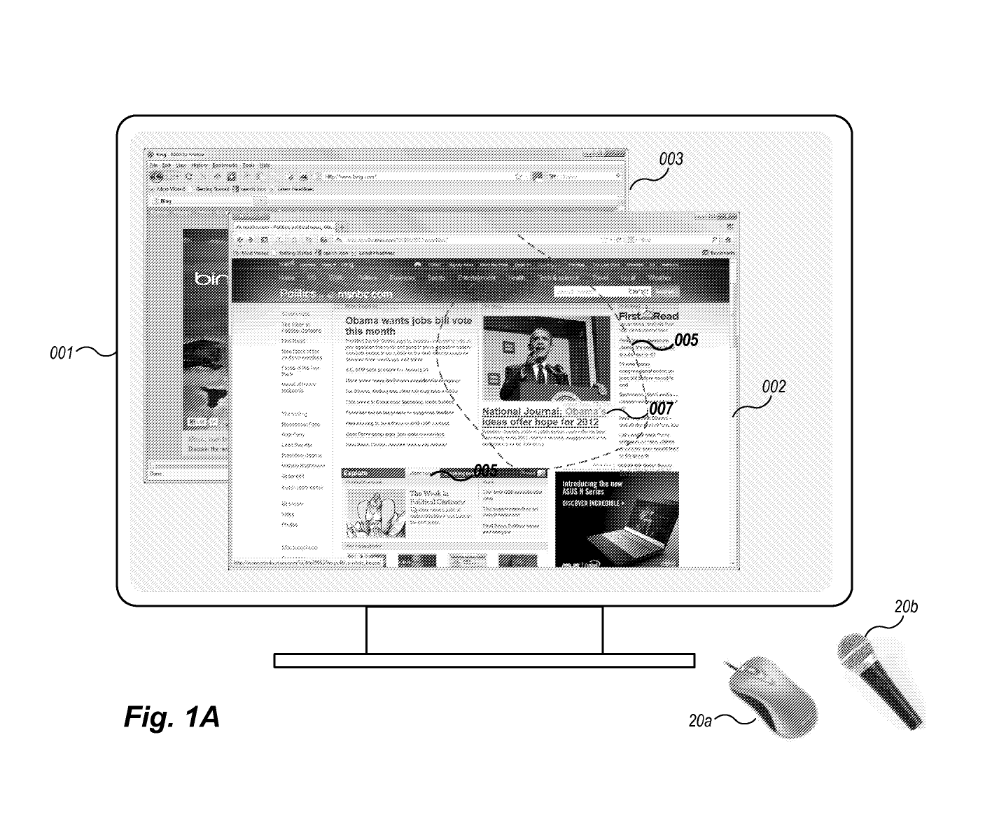

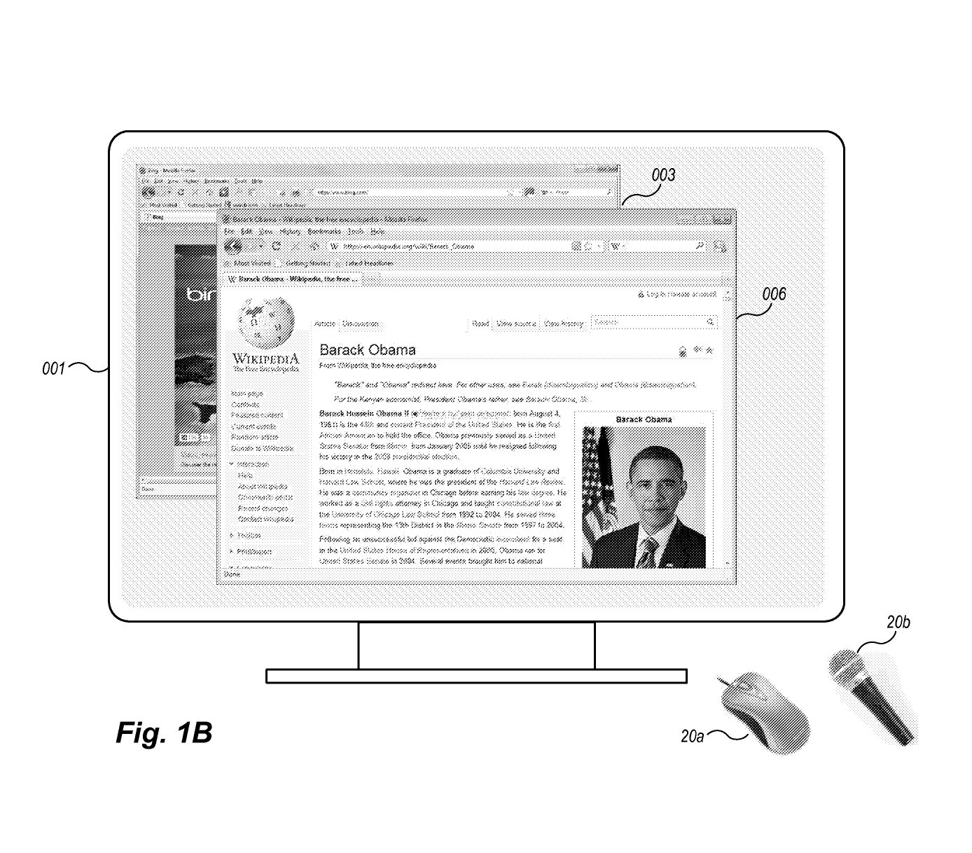

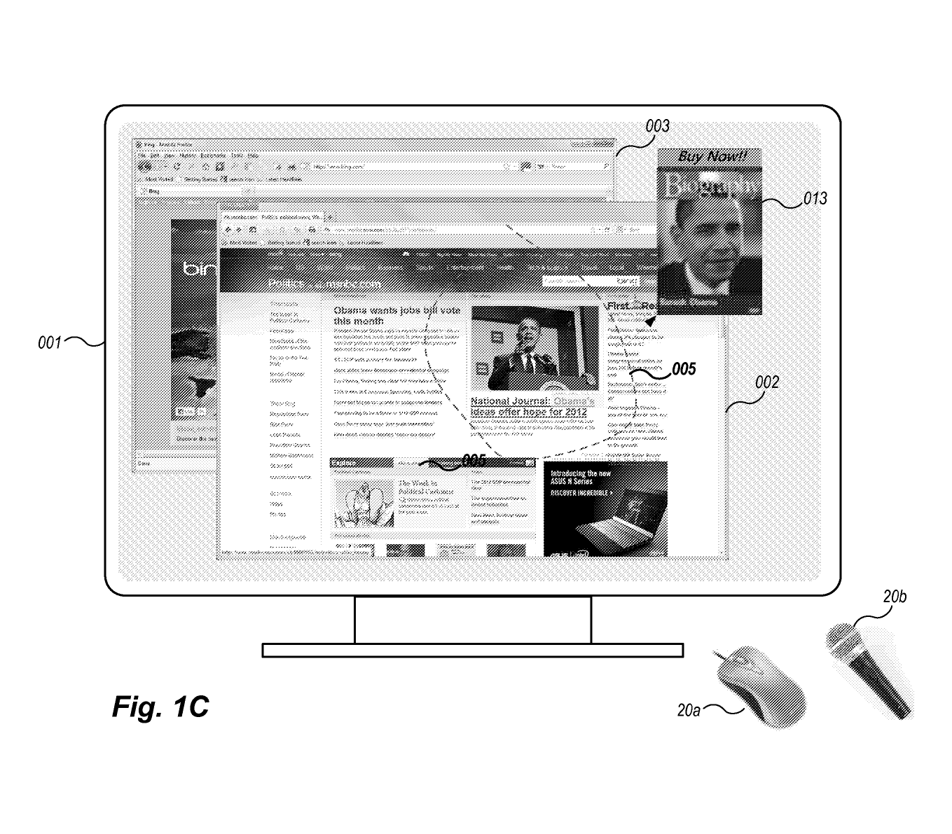

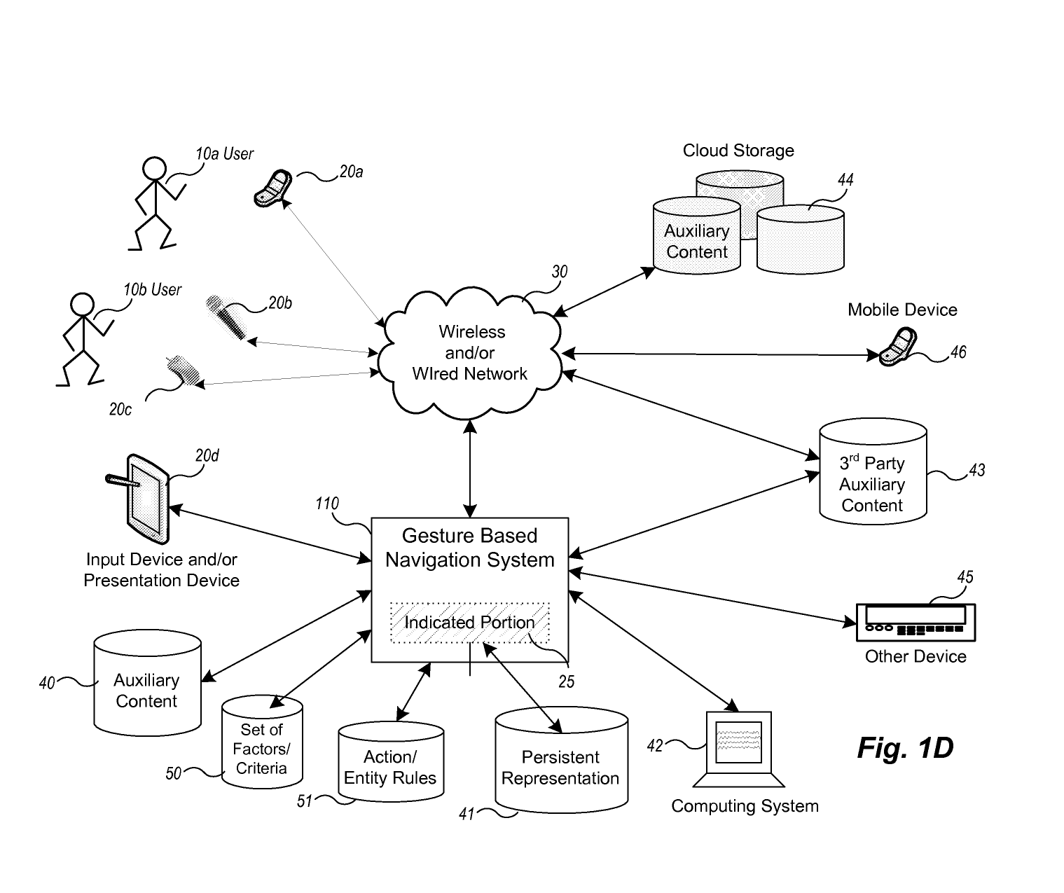

FIG. 1A is a screen display of example gesture based input performed by an example Gesture Based Navigation System (GBNS) or process. In FIG. 1A, a presentation device, such as computer display screen 001, is shown presenting two windows with electronic content, window 002 and window 003. The user (not shown) utilizes an input device, such as mouse 20a and/or a microphone 20b, to indicate a gesture (e.g., gesture 005) to the GBNS. The GBNS, as will be described in detail elsewhere herein, determines to which portion of the electronic content displayed in window 002 the gesture 005 corresponds, potentially including what type of gesture. In the example illustrated, gesture 005 was created using the mouse device 20a and represents a closed path (shown in red) that is not quite a circle or oval that indicates that the user is interested in the entity “Obama.” The gesture may be a circle, oval, closed path, polygon, or essentially any other shape recognizable by the GBNS. The gesture may indicate content that is contiguous or non-contiguous. Audio may also be used to indicate some area of the presented content, such as by using a spoken word, phrase, and/or direction (e.g., command, order, directional command, or the like). Other embodiments provide additional ways to indicate input by means of a gesture. The GBNS can be fitted to incorporate any technique for providing a gesture that indicates some area or portion (including any or all) of presented content. The GBNS has highlighted the text 007 to which gesture 005 is determined to correspond.

In the example illustrated, the GBNS determines from the indicated portion (the text “Obama”) and one or more factors, such as the user's prior navigation history, that the user may be interested in more detailed information regarding the indicated portion. In this case, the user has been known to employ “Wikipedia” for obtaining detailed information about entities. Thus, the GBNS navigates to additional content on the entity Obama available from Wikipedia (after, for example, performing a search using a search engine locally or remotely coupled to the system). In this case, any search engine could be employed, such as a keyword search engine like Bing, Google, Yahoo, or the like.

FIG. 1B is a screen display of an example gesture based auxiliary content determined by an example Gesture Based Navigation System or process. In this example, the auxiliary content is the web page 006 resulting from a search for the entity “Obama” from Wikipedia. This content is shown as an overlay over one of the windows 003 on the presentation device 001. The user could continue navigating from here to other auxiliary content using gestures to find more detailed information on Obama, for example, by indicating by a gesture an additional entity or action that the user desires information on.

For the purposes of this description, an “entity” is any person, place, or thing, or a representative of the same, such as by an icon, image, video, utterance, etc. An “action” is something that can be performed, for example, as represented by a verb, an icon, an utterance, or the like.

Suppose, on the other hand, the GBNS determined from FIG. 1A that the user tended to like to use the computer for purchases. In this case, the GBNS may surmise this as one of the factors for choosing auxiliary content by looking at the user's prior navigation history, purchase history, or the like. In this case, the GBNS determines that an opportunity for commercialization, such as an advertisement, should be a target auxiliary content.

FIG. 1C is a screen display of an example gesture based auxiliary content determined by an example Gesture Based Navigation System or process. In this example, an advertisement for a book 013 on the entity “Obama” (the gestured indicated portion) is presented alongside the gestured input 005 on window 002. The user could next use the gestural input system to select the advertisement on the book on “Obama” to create a purchase opportunity.

In FIG. 1C, the advertisement is shown as an overlay over both windows 002 and 003 on the presentation device 001. In other examples, the auxiliary content may be displayed in a separate pane, window, frame, or other construct. In some examples, the auxiliary content is brought into view in an animated fashion from one side of the screen and partially overlaid on top of the presented electronic content that the user is viewing. For example, the auxiliary content may appear to “move into place” from one side of a presentation device. In other examples, the auxiliary content may be placed in another window, pane, frame, or the like, which may or may not be juxtaposed, overlaid, or just placed in conjunction with to the initial presented content. Other arrangements are of course contemplated.

In some embodiments, the GBNS may interact with one or more remote and/or third party systems to determine and to navigate to (e.g., be routed to) auxiliary content. For example, to achieve the presentation illustrated in FIG. 1C, the GBNS may invoke a third party advertising supplier system to cause it to serve (e.g., deliver, forward, send, communicate, etc.) an appropriate advertisement oriented to other factors related to the user, such as gender, age, location, etc.

FIG. 1D is a block diagram of an example environment for determining and navigating to auxiliary content using an example Gesture Based Navigation System (GBNS) or process. One or more users 10a, 10b, etc. communicate to the GBNS 110 through one or more networks, for example, wireless and/or wired network 30, by indicating gestures using one or more input devices, for example a mobile device 20a, an audio device such as a microphone 20b, or a pointer device such as mouse 20c or the stylus on table device 20d (or for example, or any other input device, such as a keyboard of a computer device or a human body part, not shown). For the purposes of this description, the nomenclature “*” indicates a wildcard (substitutable letter(s)). Thus, user 20* may indicate a device 20a or a device 20b. The one or more networks 30 may be any type of communications link, including for example, a local area network or a wide area network such as the Internet.

Auxiliary content may be determined and navigated to as a user indicates, by means of a gesture, different portions of the presented content. Many different mechanisms for causing navigation to be initiated and auxiliary content to be presented can be accommodated, for example, a “single-click” of a mouse button following the gesture, a command via an audio input device such as microphone 20b, a secondary gesture, etc. Or in some cases, the determination and navigation is initiated automatically as a direct result of the gesture—without additional input—for example, as soon as the GBNS determines the gesture is complete.

For example, once the user has provided gestured input, the GBNS 110 will determine to what portion the gesture corresponds. In some embodiments, the GBNS 110 may take into account other factors in addition to the indicated portion of the presented content. The GBNS 110 determines the indicated portion 25 to which the gesture-based input corresponds, and then, based upon the indicated portion 25, and possibly a set of factors 50, (and, in the case of a context menu, based upon a set of action/entity rules 51) determines auxiliary content. Then, once the auxiliary content is determined (e.g., indicated, linked to, referred to, obtained, or the like) the GBNS 110 presents the auxiliary content.

The set of factors (e.g., criteria) 50 may be dynamically determined, predetermined, local to the GBNS 110, or stored or supplied externally from the GBNS 110 as described elsewhere. This set of factors may include a variety of aspects, including, for example: context of the indicated portion of the presented content, such as other words, symbols, and/or graphics nearby the indicated portion, the location of the indicated portion in the presented content, syntactic and semantic considerations, etc.; attributes of the user, for example, prior search, purchase, and/or navigation history, demographic information, and the like; attributes of the gesture, for example, direction, size, shape, color, steering, and the like; and other criteria, whether currently defined or defined in the future. In this manner, the GBNS 110 allows navigation to become “personalized” to the user as much as the system is tuned.

As explained with reference to FIGS. 1A-1C, (an indication to) the auxiliary content is determined by inference—based upon the content encompassed by the gesture and a set of factors. This contrasts to explicit navigation where the user directs the system what next content to navigate to. In some embodiments, the GBNS may incorporate a mixture of user direction (e.g., from a context menu or the like) and inference to determine an indication of auxiliary content to navigate to. The auxiliary content may be stored local to the GBNS 110, for example, in auxiliary content data repository 40 associated with a computing system running the GBNS 110, or may be stored or available externally, for example, from another computing system 42, from third party content 43 (e.g., a 3^{rd} party advertising system, external content, a social network, etc.) from auxiliary content stored using cloud storage 44, from another device 45 (such as from a settop box, A/V component, etc.), from a mobile device connected directly or indirectly with the user (e.g., from a device associated with a social network associated with the user, etc.), and/or from other devices or systems not illustrated. Third party content 43 is demonstrated as being communicatively connected to both the GBNS 110 directly and/or through the one or more networks 30. Although not shown, various of the devices and/or systems 42-46 also may be communicatively connected to the GBNS 110 directly or indirectly. The auxiliary content may be any type of content and, for example, may include another document, an image, an audio snippet, an audio visual presentation, an advertisement, an opportunity for commercialization such as a bid, a product offer, a service offer, or a competition, and the like. Once the GBNS 110 obtains the auxiliary content to present, the GBNS 110 causes the auxiliary to be presented on a presentation device (e.g., presentation device 20d) associated with the user.

The GBNS 110 illustrated in FIG. 1D may be executing (e.g., running, invoked, instantiated, or the like) on a client or on a server device or computing system. For example, a client application (e.g., a web application, web browser, other application, etc.) may be executing on one of the presentation devices, such as tablet 20d. In some embodiments, some portion or all of the GBNS 110 components may be executing as part of the client application (for example, downloaded as a plug-in, active-x component, run as a script or as part of a monolithic application, etc.). In other embodiments, some portion or all of the GBNS 110 components may be executing as a server (e.g., server application, server computing system, software as a service, etc.) remotely from the client input and/or presentation devices 20a-d.

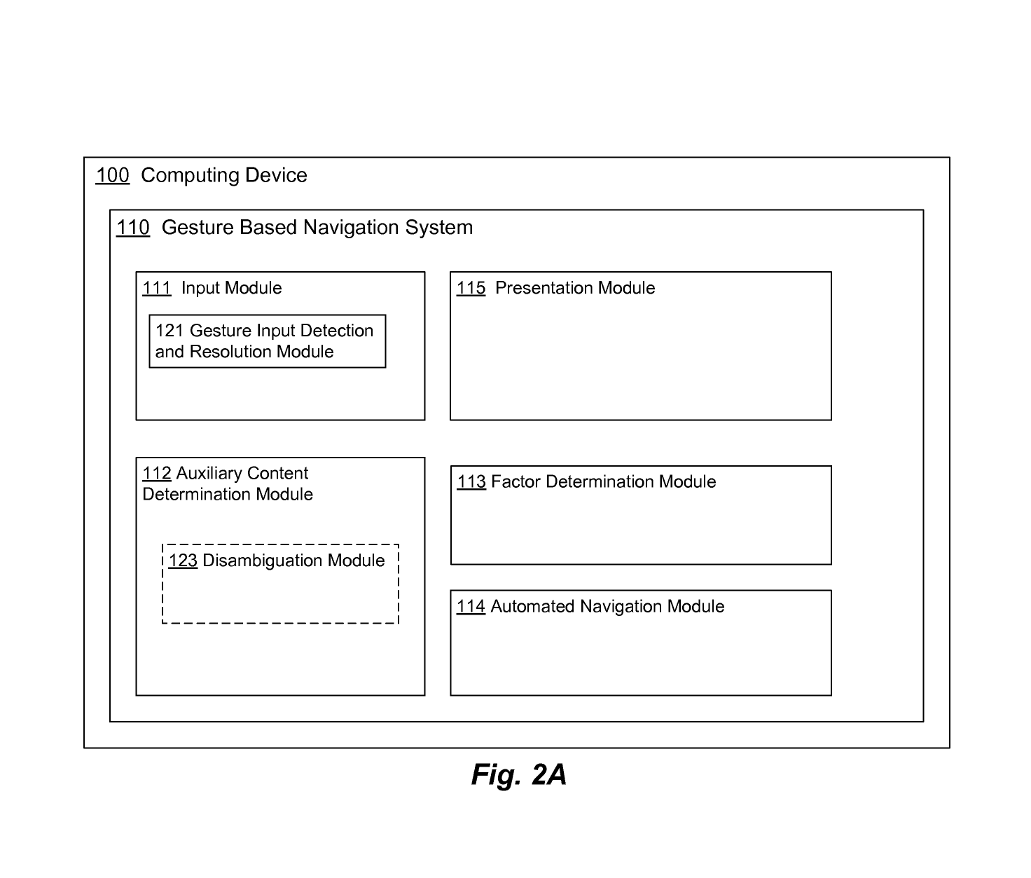

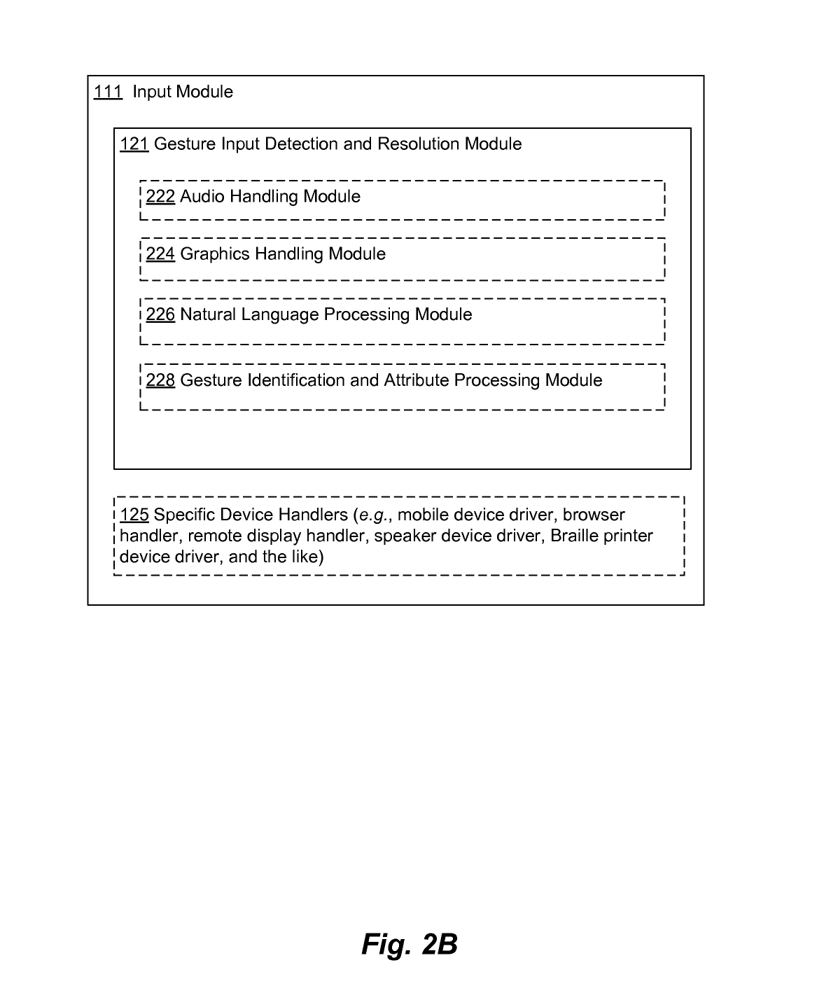

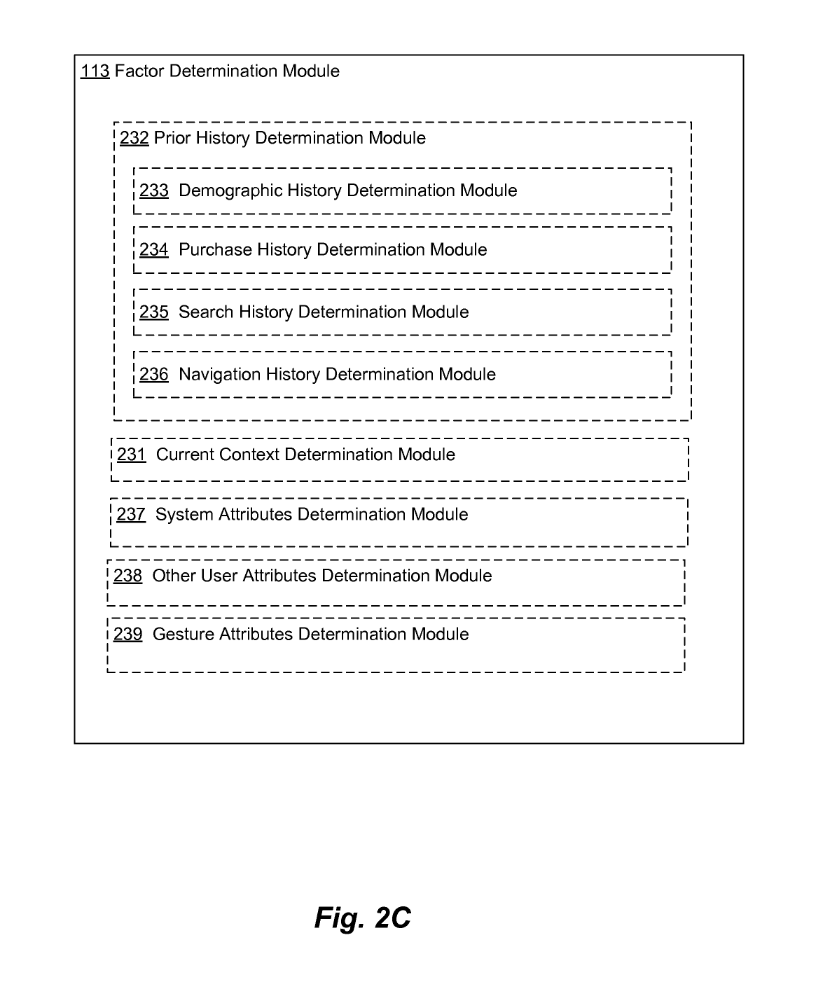

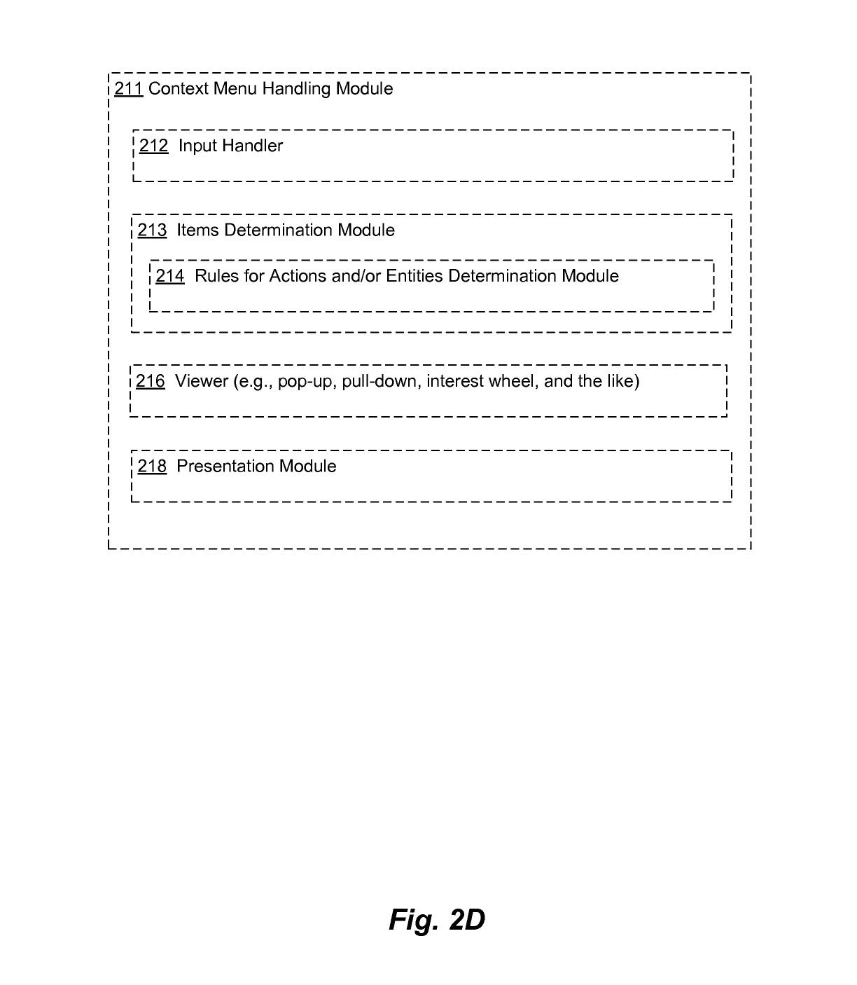

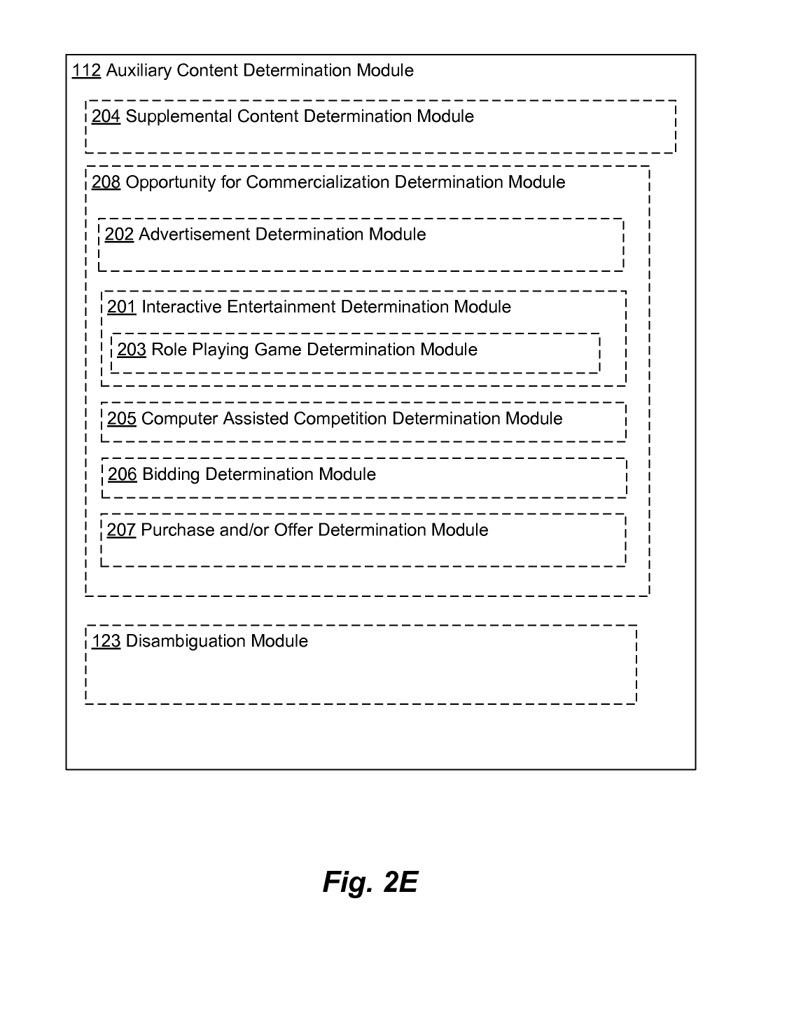

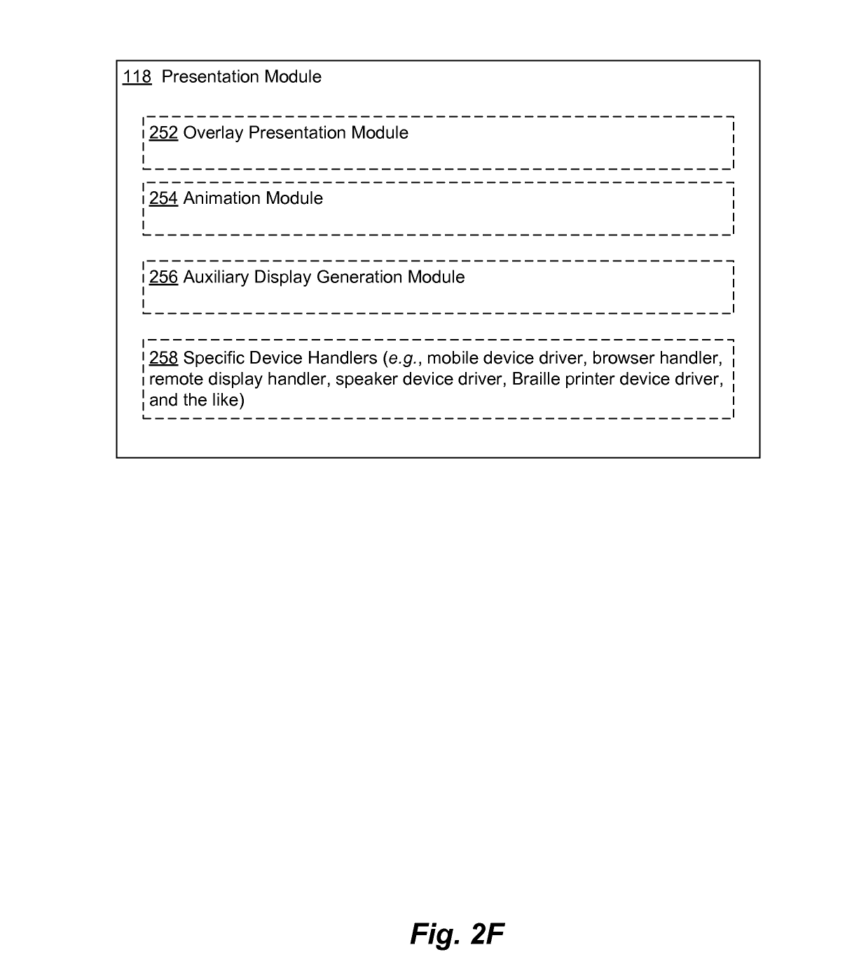

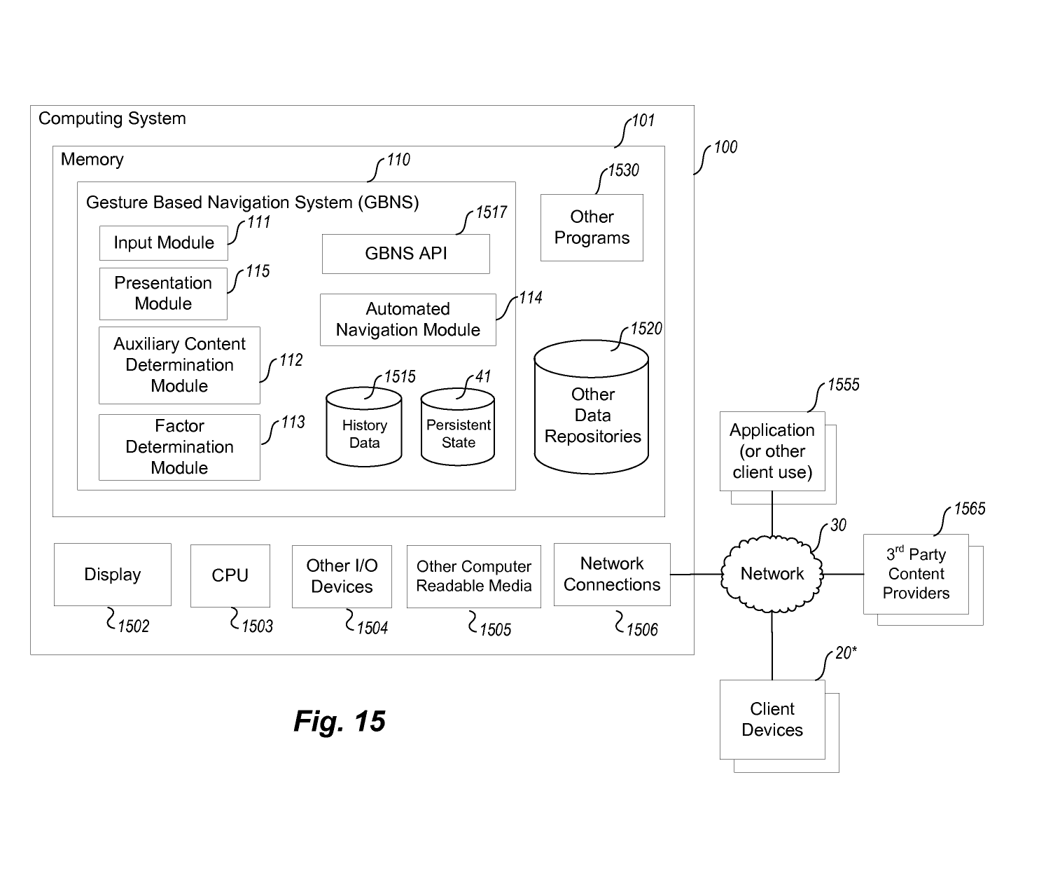

FIG. 2A is an example block diagram of components of an example Gesture Based Navigation System. In example GBNSes such as GBNS 110 of FIG. 1D, the GBNS comprises one or more functional components/modules that work together to automatically navigate to auxiliary content based upon gestured input. For example, a Gesture Based Navigation System 110 may reside in (e.g., execute thereupon, be stored in, operate with, etc.) a computing device 100 programmed with logic to effectuate the purposes of the GBNS 110. As mentioned, a GBNS 110 may be executed client side or server side. For ease of description, the GBNS 110 is described as though it is operating as a server. It is to be understood that equivalent client side modules can be implemented. Moreover, such client side modules need not operate in a client-server environment, as the GBNS 110 may be practiced in a standalone environment or even embedded into another apparatus. Moreover, the GBNS 110 may be implemented in hardware, software, or firmware, or in some combination. In addition, although auxiliary content is typically presented on a client presentation device such as devices 20*, the content may be implemented server-side or some combination of both. Details of the computing device/system 100 are described below with reference to FIG. 15.

In an example system, a GBNS 110 comprises an input module 111, an auxiliary content determination module 112, a factor determination module 113, an automated navigation module 114, and a presentation module 115. In some embodiments the GBNS 110 comprises additional and/or different modules as described further below.

Input module 111 is configured and responsible for determining the gesture and an indication of an area (e.g., a portion) of the presented electronic content indicated by the gesture. In some example systems, the input module 111 comprises a gesture input detection and resolution module 121 to aid in this process. The gesture input detection and resolution module 121 is responsible for determining, using different techniques, for example, pattern matching, parsing, heuristics, etc. to what area a gesture corresponds and what word, phrase, image, audio clip, etc. is indicated.

Auxiliary content determination module 112 is configured and responsible for determining the next content to be navigated to. As explained, this determination may be based upon the context—the portion indicated by the gesture and potentially a set of factors (e.g., criteria, properties, aspects, or the like) that help to define context. The auxiliary content determination module 112 may invoke the factor determination module 113 to determine the one or more factors to use to assist in determining the auxiliary content by inference. The factor determination module 113 may comprise a variety of implementations corresponding to different types of factors, for example, modules for determining prior history associated with the user, current context, gesture attributes, system attributes, or the like.

In some cases, for example, when the portion of content indicated by the gesture is ambiguous or not clear by the indicated portion itself, the auxiliary content determination module 112 may utilize a disambiguation module 123 to help disambiguate the indicated portion of content. For example, if a gesture has indicated the word “Bill,” the disambiguation module 123 may help distinguish whether the user is likely interested in a person whose name is Bill or a legislative proposal. In addition, based upon the indicated portion of content and the set of factors, more than one auxiliary content may be identified. If this is the case, then the auxiliary content determination module 112 may use the disambiguation module 123 and other logic to select an auxiliary content to navigate to.

Once the auxiliary content is determined, the GBNS 110 uses the automated navigation module 114 to navigate to the auxiliary content. The GBNS 110 forwards (e.g., communicates, sends, pushes, etc.) the auxiliary content to the presentation module 115 to cause the presentation module 115 to present the auxiliary content or cause another device to present it. The auxiliary content may be presented in a variety of manners, including via visual display, audio display, via a Braille printer, etc., and using different techniques, for example, overlays, animation, etc.

FIG. 2B is an example block diagram of further components of the Input Module of an example Gesture Based Navigation System. In some example systems, the input module 111 may be configured to include a variety of other modules and/or logic. For example, the input module 111 may be configured to include a gesture input detection and resolution module 121 as described with reference to FIG. 2A. The gesture input detection and resolution module 121 may be further configured to include a variety of modules and logic for handling a variety of input devices and systems. For example, gesture input detection and resolution module 121 may be configured to include an audio handling module 222 for handling gesture input by way of audio devices and/or a graphics handling module 224 for handing the association of gestures to graphics in content (such as an icon, image, movie, still, sequence of frames, etc.). In addition, in some example systems, the input module 111 may be configured to include a natural language processing module 226. Natural language processing (NLP) module 226 may be used, for example, to detect whether a gesture is meant to indicate a word, a phrase, a sentence, a paragraph, or some other portion of presented electronic content using techniques such as syntactic and/or semantic analysis of the content. In some example systems, the input module 111 may be configured to include a gesture identification and attribute processing module 228 for handling other aspects of gesture determination such as determining the particular type of gesture (e.g., a circle, oval, polygon, closed path, check mark, box, or the like) or whether a particular gesture is a “steering” gesture that is meant to correct, for example, an initial path indicated by a gesture; a “smudge” which may have its own interpretation such as extend the gesture “here;” the color of the gesture, for example, if the input device supports the equivalent of a colored “pen” (e.g., pens that allow a user can select blue, black, red, or green); the size of a gesture (e.g., whether the gesture draws a thick or thin line, whether the gesture is a small or large circle, and the like); the direction of the gesture (up, down, across, etc.); and/or other attributes of a gesture.

In some example systems, the input module 111 is configured to include specific device handlers 125 (e.g., drivers) for detecting and controlling input from the various types of input devices, for example devices 20*. For example, specific device handlers 125 may include a mobile device driver, a browser “device” driver, a remote display “device” driver, a speaker device driver, a Braille printer device driver, and the like. The input module 111 may be configured to work with and or dynamically add other and/or different device handlers.

Other modules and logic may be also configured to be used with the input module 111.

FIG. 2C is an example block diagram of further components of the Factor Determination Module of an example Gesture Based Navigation System. In some example systems, the factor determination module 113 may be configured to include a prior history determination module 232, a system attributes determination module 237, other user attributes determination module 238, a gesture attributes determination module 239, and/or current context determination module 231.

In some example systems, the prior history determination module 232 determines (e.g., finds, establishes, selects, realizes, resolves, establishes, etc.) prior histories associated with the user and is configured to include modules/logic to implement such. For example, the prior history determination module 232 may be configured to include a demographic history determination module 233 that is configured to determine demographics (such as age, gender, residence location, citizenship, languages spoken, or the like) associated with the user. The prior history determination module 232 may be configured to include a purchase history determination module 234 that is configured to determine a user's prior purchases. The purchase history may be available electronically, over the network, may be integrated from manual records, or some combination. In some systems, these purchases may be product and/or service purchases. The prior history determination module 232 may be configured to include a search history determination module 235 that is configured to determine a user's prior searches. Such records may be stored locally with the GBNS 110 or may be available over the network 30 or using a third party service, etc. The prior history determination module 232 also may be configured to include a navigation history determination module 236 that is configured to keep track of and/or determine how a user navigates through his or her computing system so that the GBNS 110 can determine aspects such as navigation preferences, commonly visited content (for example, commonly visited websites or bookmarked items), etc.

The factor determination module 113 may be configured to include a system attributes determination module 237 that is configured to determine aspects of the “system” that may provide influence or guidance (e.g., may inform) the determination of which menu items are appropriate for the portion of content indicated by the gestured input. These may include aspects of the GBNS 110, aspects of the system that is executing the GBNS 119 (e.g., the computing system 100), aspects of a system associated with the GBNS 110 (e.g., a third party system), network statistics, and/or the like.

The factor determination module 113 also may be configured to include other user attributes determination module 238 that is configured to determine other attributes associated with the user not covered by the prior history determination module 232. For example, a user's social connectivity data may be determined by module 238.

The factor determination module 113 also may be configured to include a gesture attributes determination module 239. The gesture attributes determination module 239 is configured to provide determinations of attributes of the gesture input, similar or different from those described relative to input module 111 and gesture attribute processing module 228 for determining to what content a gesture corresponds. Thus, for example, the gesture attributes determination module 239 may provide information and statistics regarding size, length, shape, color, and/or direction of a gesture.

The factor determination module 113 also may be configured to include a current context determination module 231. The current context determination module 231 is configured to provide determinations of attributes regarding what the user is viewing, the underlying content, context relative to other containing content (if known), whether the gesture has selected a word or phrase that is located with certain areas of presented content (such as the title, abstract, a review, and so forth). Other modules and logic may be also configured to be used with the factor determination module 113.

In some embodiments, the GBNS uses context menus, for example, to allow a user to modify a gesture or to assist the GBNS is inferring what auxiliary content is appropriate. FIG. 2D is an example block diagram of further components of a Context Menu Handling Module of an example Gesture Based Navigation System. The context module 112 may be used to obtain auxiliary input from the user. In such a case, the context menu handling module 211 may be configured to process and handle menu presentation and input. The context menu handling module 211 may be configured to include a variety of other modules and/or logic. For example, the context menu handling module 211 may be configured to include an items determination module 212 for determining what menu items to present on a particular menu, an input handler 214 for providing an event loop to detect and handle user selection of a menu item, a viewer module 216 to determine what kind of “view” (as in a model/view/controller—MVC—model) to present (e.g., a pop-up, pull-down, dialog, interest wheel, and the like) and a presentation module 215 for determining when and what to present to the user and to determine an auxiliary content to present that is associated with a selection. In some embodiments, the items determination module 213 may use a rules for actions and/or entities determination module 214 to determine what to present on a particular menu.

FIG. 2E is an example block diagram of further components of the Auxiliary Content Determination Module of an example Gesture Based Navigation System. In some example systems, the auxiliary content determination module 122 is configured to determine (e.g., find, establish, select, realize, resolve, establish, etc.) auxiliary or supplemental content that best matches the gestured input and/or a set of factors. Best match may include content that is, for example, most related syntactically or semantically, closest in “proximity” however proximity is defined (e.g., content that relates to a relative of the user or the user's social network), most often navigated to given the entity(ies) encompassed by the gesture, and the like. Other definitions for determined what auxiliary content best relates to the gestured input and/or one or more of the set of factors is contemplated and can be incorporated by the GBNS.

The auxiliary content determination module 122 may be further configured to include a variety of different modules to aid in this determination process. For example, the auxiliary content determination module 122 may be configured to include an advertisement determination module 202 to determine one or more advertisements that can be associated with the gestured input. For example, as shown in FIG. 1C, these advertisements may be provided by a variety of sources including from local storage, over a network (e.g., wide area network such as the Internet, a local area network, a proprietary network, an Intranet, or the like), from a known source provider, from third party content (available, for example from cloud storage or from the provider's repositories), and the like. In some systems, a third party advertisement provider system is used that is configured to accept queries for advertisements (“ads”) such as using keywords, to output appropriate advertising content.

In some example systems the auxiliary content determination module 122 is further configured to provide a supplemental content determination module 204. The supplemental content determination module 204 may be configured to determine other content that somehow relates to (e.g., associated with, supplements, improves upon, corresponds to, has the opposite meaning from, etc.) the gestured input.

In some example systems the auxiliary content determination module 122 is further configured to provide an opportunity for commercialization determination module 208 to find a commercialization opportunity appropriate for the area indicated by the gesture. In some such systems, the commercialization opportunities may include events such as purchase and/or offers, and the opportunity for commercialization determination module 208 may be further configured to include an interactive entertainment determination module 201, which may be further configured to include a role playing game determination module 203, a computer assisted competition determination module 205, a bidding determination module 206, and a purchase and/or offer determination module 207 with logic to aid in determining a purchase and/or an offer as auxiliary content.

The auxiliary content determination module also may use a disambiguation module 123 when perhaps more than one auxiliary content is determined by the GBNS to apply to the content of the indicated portion and any factors considered. The disambiguation module 123 may utilize syntactic and/or semantic aids, user selection, default values, and the like to assist in the determination of auxiliary content. Other modules and logic may be also configured to be used with the auxiliary content determination module 122.

FIG. 2F is an example block diagram of further components of the Presentation Module of an example Gesture Based Navigation System. In some example systems, the presentation module 115 may be configured to include a variety of other modules and/or logic. For example, the presentation module 115 may be configured to include an overlay presentation module 252 for determined how to present auxiliary content determined by the content to present determination module 116 on a presentation device, such as tablet 20d. Overlay presentation module 252 may utilize knowledge of the presentation devices to decide how to integrate the auxiliary content as an “overlay” (e.g., covering up a portion or all of the underlying presented content). For example, when the GBNS 110 is run as a server application that serves web pages to a client side web browser, certain configurations using “html” commands or other tags may be used.

Presentation module 115 also may be configured to include an animation module 254. In some example systems, the auxiliary content may be “moved in” from one side or portion of a presentation device in an animated manner. For example, the auxiliary content may be placed in a pane (e.g., a window, frame, pane, etc., as appropriate to the underlying operating system or application running on the presentation device) that is moved in from one side of the display onto the content previously shown (a form of navigation to the auxiliary content). Other animations can be similarly incorporated.

Presentation module 115 also may be configured to include an auxiliary display generation module 256 for generating a new graphic or audio construct to be presented in conjunction with the content already displayed on the presentation device. In some systems, the new content is presented in a new window, frame, pane, or other auxiliary display construct.

Presentation module 115 also may be configured to include specific device handlers 258, for example device drivers configured to communicate with mobile devices, remote displays, speakers, Braille printers, and/or the like as described elsewhere. Other or different presentation device handlers may be similarly incorporated.

Also, other modules and logic may be also configured to be used with the presentation module 115.

Although the techniques of a Gesture Based Navigation System (GBNS) are generally applicable to any type of gesture-based system, the phrase “gesture” is used generally to imply any type of physical pointing type of gesture or audio equivalent. In addition, although the examples described herein often refer to online electronic content such as available over a network such as the Internet, the techniques described herein can also be used by a local area network system or in a system without a network. In addition, the concepts and techniques described are applicable to other input and presentation devices. Essentially, the concepts and techniques described are applicable to any environment that supports some type of gesture-based input.

Also, although certain terms are used primarily herein, other terms could be used interchangeably to yield equivalent embodiments and examples. In addition, terms may have alternate spellings which may or may not be explicitly mentioned, and all such variations of terms are intended to be included.

Example embodiments described herein provide applications, tools, data structures and other support to implement a Gesture Based Navigation System (GBNS) to be used for providing gesture based navigation. Other embodiments of the described techniques may be used for other purposes. In the following description, numerous specific details are set forth, such as data formats and code sequences, etc., in order to provide a thorough understanding of the described techniques. The embodiments described also can be practiced without some of the specific details described herein, or with other specific details, such as changes with respect to the ordering of the logic or code flow, different logic, or the like. Thus, the scope of the techniques and/or components/modules described are not limited by the particular order, selection, or decomposition of logic described with reference to any particular routine.

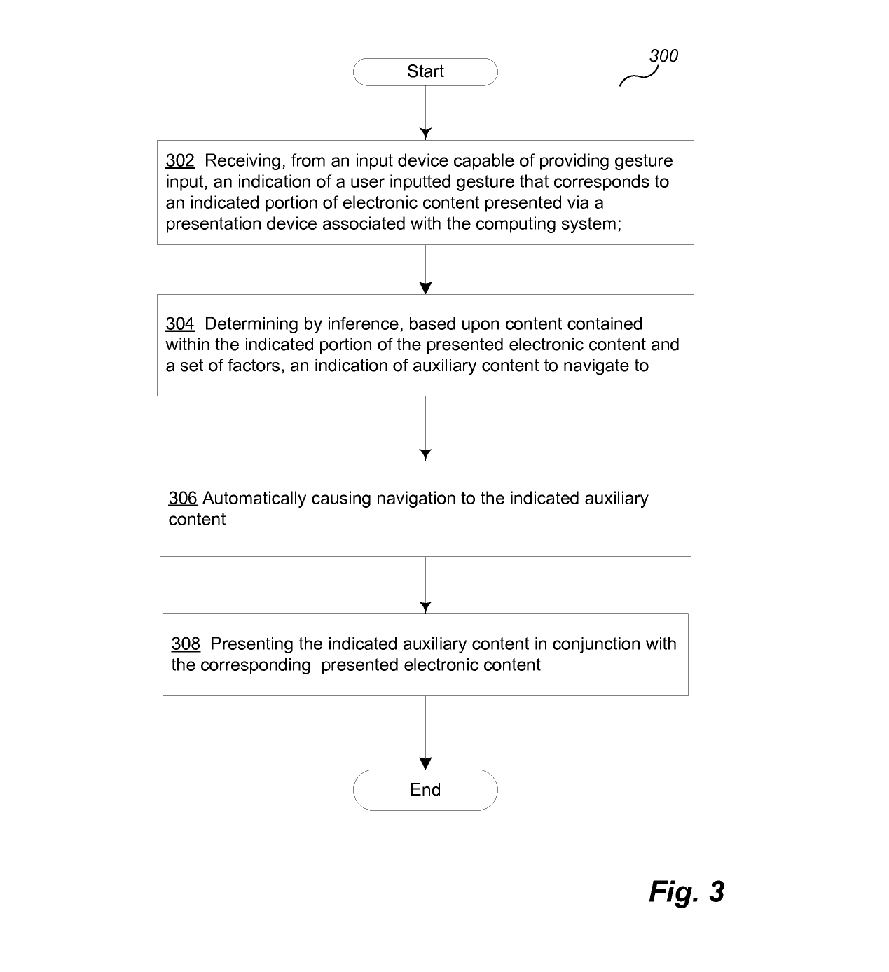

FIGS. 3-15 include example flow diagrams of various example logic that may be used to implement embodiments of a Gesture Based Navigation System (GBNS). The example logic will be described with respect to the example components of example embodiments of a GBNS as described above with respect to FIGS. 1A-2F. However, it is to be understood that the flows and logic may be executed in a number of other environments, systems, and contexts, and/or in modified versions of those described. In addition, various logic blocks (e.g., operations, events, activities, or the like) may be illustrated in a “box-within-a-box” manner. Such illustrations may indicate that the logic in an internal box may comprise an optional example embodiment of the logic illustrated in one or more (containing) external boxes. However, it is to be understood that internal box logic may be viewed as independent logic separate from any associated external boxes and may be performed in other sequences or concurrently.

FIG. 3 is an example flow diagram of example logic for providing gesture based navigation to auxiliary content. Operational flow 300 includes several operations. In operation 302, the logic performs receiving, from an input device capable of providing gesture input, an indication of a user inputted gesture that corresponds to an indicated portion of electronic content presented via a presentation device associated with the computing system. This logic may be performed, for example, by the input module 111 of the GBNS 110 described with reference to FIGS. 2A and 2B by receiving (e.g., obtaining, getting, extracting, and so forth), from an input device capable of providing gesture input (e.g., devices 20*), an indication of a user inputted gesture that corresponds to an indicated portion (e.g., indicated portion 25) on electronic content presented via a presentation device (e.g., 20*) associated with the computing system 100. One or more of the modules provided by gesture input detection and resolution module 121, including the audio handling module 222, graphics handling module 224, natural language processing module 226, and/or gesture identification and attribute processing module 228 may be used to assist in operation 302. As described in detail elsewhere, the indicated portion may be formed from contiguous or composed of separate non-contiguous parts, for example, a title with a disconnected sentence. In addition, the indicated portion may represent the entire body of electronic content presented to the user or a part. Also as described elsewhere, the gestural input may be of different forms, including, for example, a circle, an oval, a closed path, a polygon, and the like. The gesture may be from a pointing device, for example, a mouse, laser pointer, a body part, and the like, or from a source of auditory input.

In operation 304, the logic performs determining by inference, based upon content contained within the indicated portion of the presented electronic content and a set of factors, an indication of auxiliary content to navigate to. This logic may be performed, for example, by the auxiliary content determination module 112 of the GBNS 110 described with reference to FIGS. 2A and 2E. As described elsewhere, the auxiliary content determination module 112 may use a factor determination module 113 to determine a set of factors (e.g., the context of the gesture, the user, or of the presented content, prior history associated with the user or the system, attributes of the gestures, and the like) to use, in addition to determining what content has been indicated by the gesture, in order to determine an indication (e.g., a reference to, what, etc.) of auxiliary content. The content contained within the indicated portion of the presented electronic content may be anything, for example, a word, phrase, utterance, video, image, or the like.

In operation 306, the logic performs automatically causing navigation to the indicated auxiliary content. This logic may be performed, for example, by the automated navigation module 114 of the GBNS 110 as described with reference to FIG. 2A. As described elsewhere, the automatically causing navigation to auxiliary content may include, for example, invoking (e.g., executing, calling, sending, or the like) a third party or remote application, a web service, local or remote code, and the like (e.g., a third party auxiliary content supply tool such as an advertising server, an application residing elsewhere, and the like). The auxiliary content may be anything, including for example, any type of auxiliary, supplement, or other content (e.g., a web page, an electronic document, code, speech, an opportunity for commercialization, an advertisement, or the like).

In operation 308, the logic performs causing the indicated auxiliary content to be presented in conjunction with the corresponding presented electronic content. This logic may be performed, for example, by the presentation module 115 of the GBNS 110 described with reference to FIGS. 2A and 2F to present (e.g., output, display, render, draw, show, illustrate, etc.) the indicated auxiliary content (e.g., a search result, an advertisement, web page, supplemental content, document, instructions, image, and the like) in conjunction with the presented electronic content (e.g., displaying the auxiliary content web page as shown in FIG. 1B or the auxiliary content advertisement as shown in FIG. 1C as an overlay on the web page that is presented corresponding to the gestured input).

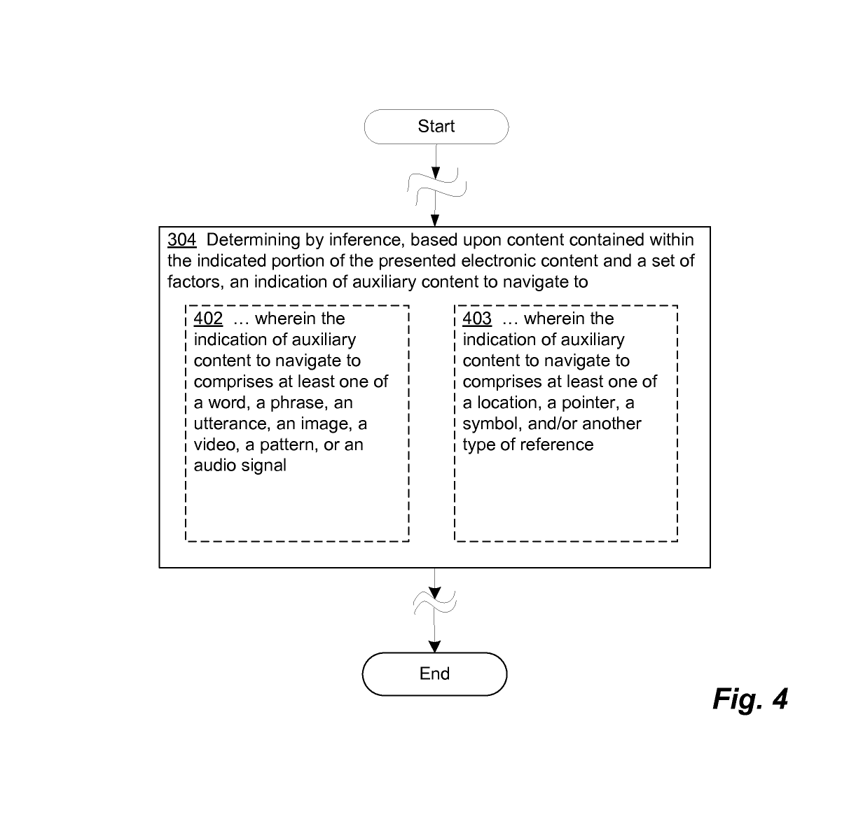

FIG. 4 is an example flow diagram of example logic illustrating various example embodiments of block 304 of FIG. 3. In some embodiments, the logic of operation 304 for determining by inference, based upon content contained within the indicated portion of the presented electronic content and a set of factors, an indication of auxiliary content to navigate to may include an operation 402 whose logic specifies the indication of auxiliary content to navigate to comprises at least one of a word, a phrase, an utterance, an image, a video, a pattern, or an audio signal. The logic of operation 402 may be performed, for example, by any of the modules of auxiliary content determination module 112 of the GBNS 110 described with reference to FIGS. 2A and 2E. For example, the disambiguation module 123 and/or one of more of the modules of the opportunity for commercialization determination module 208 may determine auxiliary content (e.g., an advertisement, web page, or the like) and return an indication. Determining by inference may include any algorithm for determining a good or best match to the content contained within the indicated portion of the electronic content combined with one or more of the set of factors, including for example, best match may include content that is, for example, most related syntactically or semantically, closest in “proximity” however proximity is defined (e.g., content that relates to a relative of the user or the user's social network), most often navigated to given the entity(ies) encompassed by the gesture, and the like.

In the same or different embodiments, operation 304 may include an operation 403 whose logic specifies that the indication of auxiliary content to navigate to comprises at least one of a location, a pointer, a symbol, and/or another type of reference. The logic of operation 403 may be performed, for example, by any of the modules of auxiliary content determination module 112 of the GBNS 110 described with reference to FIGS. 2A and 2E. In this case, the indication is one of a location, a pointer, a symbol, (e.g., an absolute or relative location, a location in memory locally or remotely, or the like) intended to enable the GBNS to find, obtain, or locate the auxiliary content in order to cause it to be presented.

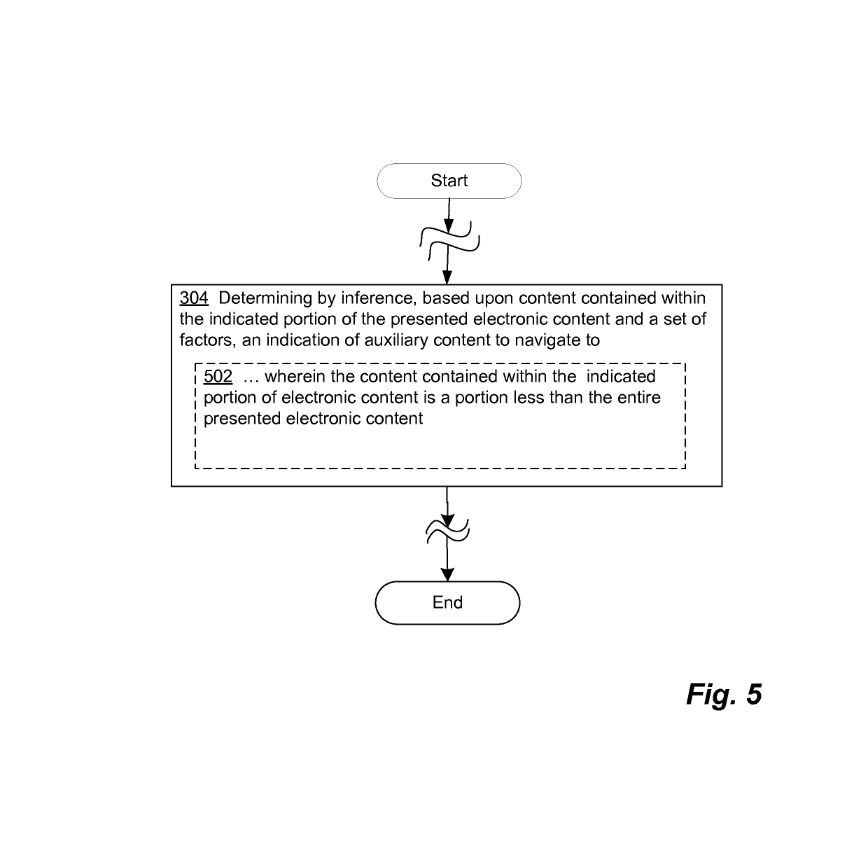

FIG. 5 is an example flow diagram of example logic illustrating various example embodiments of block 304 of FIG. 3. In some embodiments, the logic of operation 304 for determining by inference, based upon content contained within the indicated portion of the presented electronic content and a set of factors, an indication of auxiliary content to navigate to may include an operation 502 whose logic specifies the content contained within the indicated portion of electronic content is a portion less than the entire presented electronic content. The logic of operation 502 may be performed, for example, by the input module 111 of the GBNS 110 described with reference to FIGS. 2A and 2B. The content determined to be contained within (e.g., represented by, indicated, etc.) the gestured portion may include for example only a portion of a presented content, such as a title and abstract of an electronically presented document.

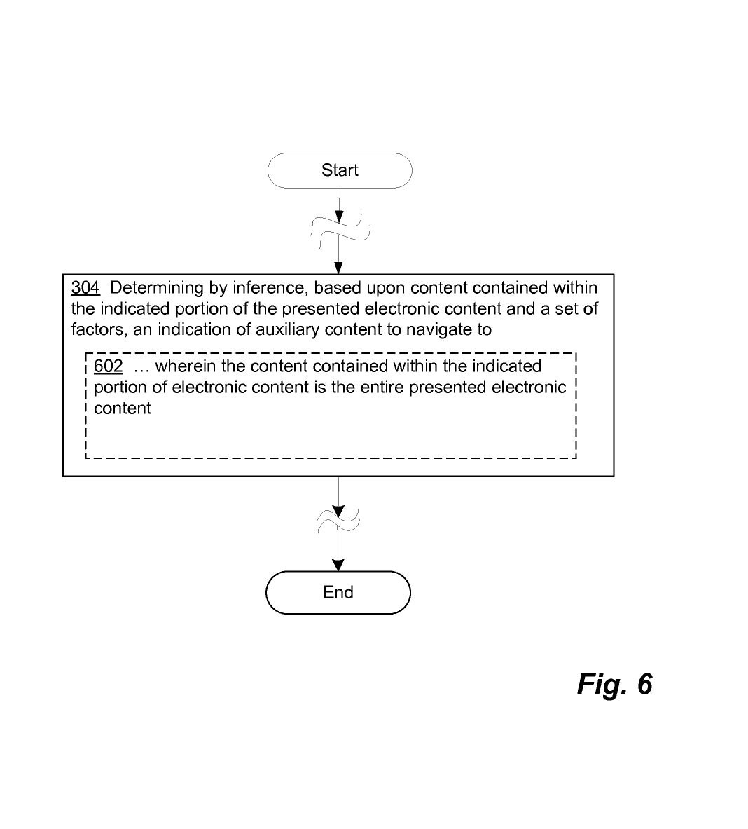

FIG. 6 is an example flow diagram of example logic illustrating various example embodiments of block 304 of FIG. 3. In some embodiments, the logic of operation 304 for determining by inference, based upon content contained within the indicated portion of the presented electronic content and a set of factors, an indication of auxiliary content to navigate to may include an operation 502 whose logic specifies the content contained within the indicated portion of electronic content is the entire presented electronic content. The logic of operation 602 may be performed, for example, by of the input module 111 of the GBNS 110 described with reference to FIGS. 2A and 2B. The content determined to be contained within (e.g., represented by, indicated, etc.) the gestured portion may include for the entire presented content, such as a whole document.

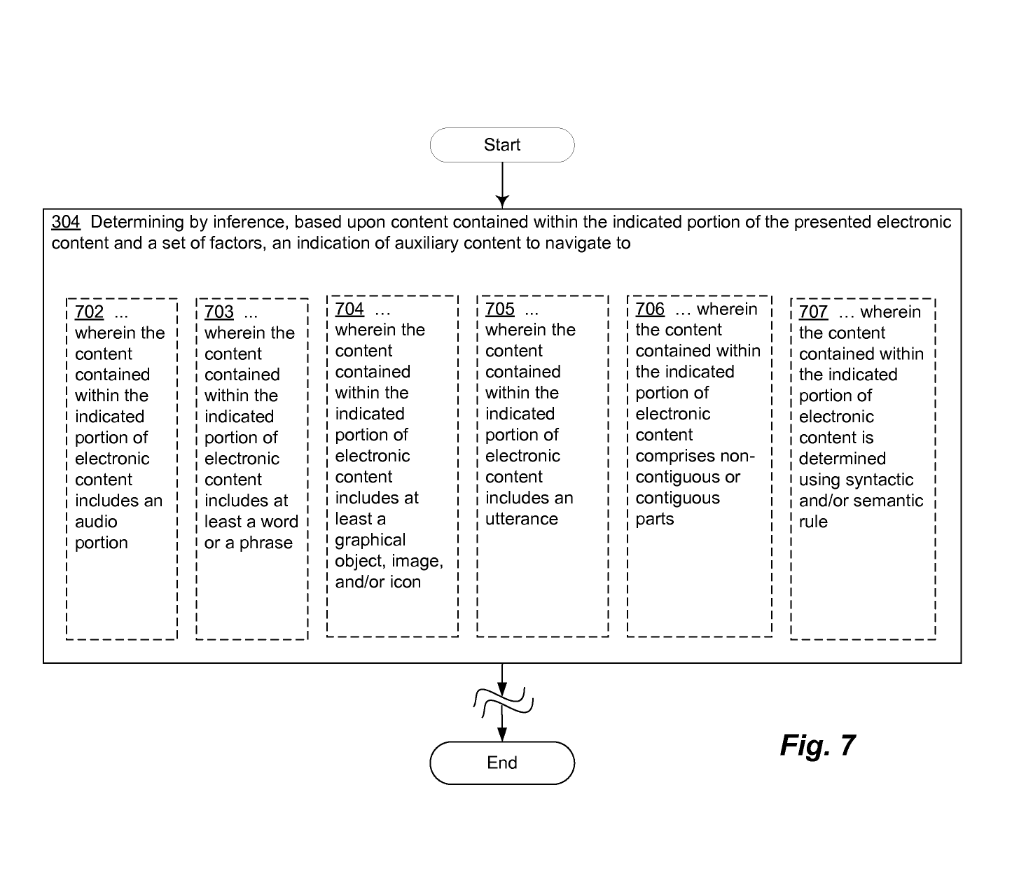

FIG. 7 is an example flow diagram of example logic illustrating various example embodiments of block 304 of FIG. 3. In some embodiments, the logic of operation 304 for determining by inference, based upon content contained within the indicated portion of the presented electronic content and a set of factors, an indication of auxiliary content to navigate to may include an operation 702 whose logic specifies the content contained within the indicated portion of electronic content includes an audio portion. The logic of operation 702 may be performed, for example, by an audio handling module 222 provided by the gesture input detection and resolution module 121 of the input module 111 of the GBNS 110 described with reference to FIGS. 2A and 2B. For example, gesture input detection and resolution module 121 may be configured to include an audio handling module 222 for handling gesture input by way of audio devices such as microphone 20b. The audio portion may be, for example, a spoken title of a presented document.

In some embodiments, operation 304 may further comprise an operation 703 whose logic specifies the content contained within the indicated portion of electronic content includes at least a word or a phrase. The logic of operation 703 may be performed, for example, by the natural language processing module 226 provided by the gesture input detection and resolution module 121 of the input module 111 of the GBNS 110 as described with reference to FIGS. 2A and 2B. NLP module 226 may be used, for example, to detect whether a gesture is meant to indicate a word, a phrase, a sentence, a paragraph, or some other portion of presented electronic content using techniques such as syntactic and/or semantic analysis of the content. The word or phrase may be any word or phrase located in or indicated by the electronically presented content.

In the same or different embodiments, operation 304 may include an operation 704 whose logic specifies the content contained within the indicated portion of electronic content includes at least a graphical object, image, and/or icon. The logic of operation 704 may be performed, for example, by the graphics handling module 224 provided by the gesture input detection and resolution module 121 of the input module 111 of the GBNS 110 as described with reference to FIGS. 2A and 2B. For example, the graphics handling module 224 may be configured to handle the association of gestures to graphics located or indicated by the presented content (such as an icon, image, movie, still, sequence of frames, etc.).

In the same or different embodiments, operation 304 may include an operation 705 whose logic specifies the content contained within the indicated portion of electronic content includes an utterance. The logic of operation 705 may be performed, for example, by an audio handling module 222 provided by the gesture input detection and resolution module 121 of the input module 111 of the GBNS 110 described with reference to FIGS. 2A and 2B. For example, gesture input detection and resolution module 121 may be configured to include an audio handling module 222 for handling gesture input by way of audio devices such as microphone 20b. The utterance may be, for example, a spoken word of a presented document, or a command, or a sound.

In the same or different embodiments, operation 304 may include an operation 706 whose logic specifies the content contained within the indicated portion of electronic content comprises non-contiguous parts or contiguous parts. The logic of operation 706 may be performed, for example, by the gesture input detection and resolution module 121 of the input module 111 of the GBNS 110 as described with reference to FIGS. 2A and 2B. For example, the contiguous parts may represent a continuous are of the presented content, such as a sentence, a portion of a paragraph, a sequence of images, or the like. Non-contiguous parts may include separate portions of the presented content that together comprise the indicated portion, such as a title and an abstract, a paragraph and the name of an author, a disconnected image and a spoken sentence, or the like.

In the same or different embodiments, operation 304 may include an operation 707 whose logic specifies the content contained within the indicated portion of electronic content is determined using syntactic and/or semantic rules. The logic of operation 707 may be performed, for example, by the natural language processing module 226 provided by the gesture input detection and resolution module 121 of the input module 111 of the GBNS 110 as described with reference to FIGS. 2A and 2B. NLP module 226 may be used, for example, to detect whether a gesture is meant to indicate a word, a phrase, a sentence, a paragraph, or some other portion of presented electronic content using techniques such as syntactic and/or semantic analysis of the content. The word or phrase may be any word or phrase located in or indicated by the electronically presented content.

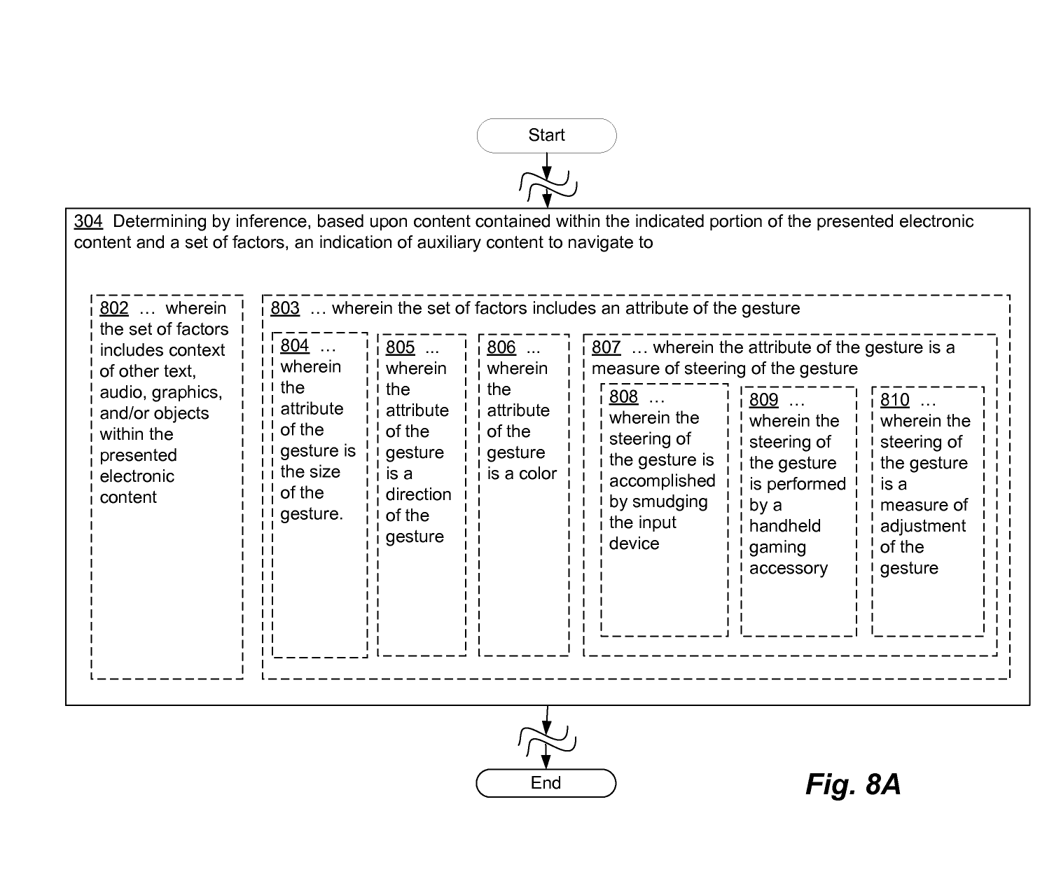

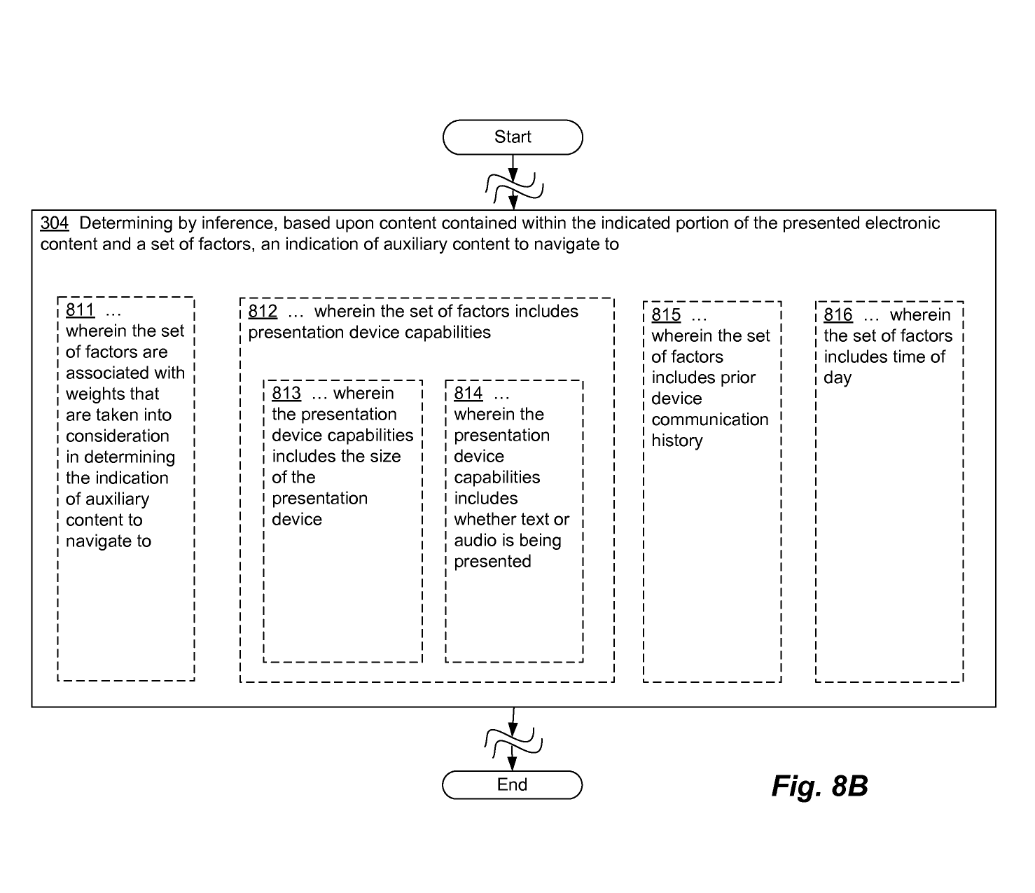

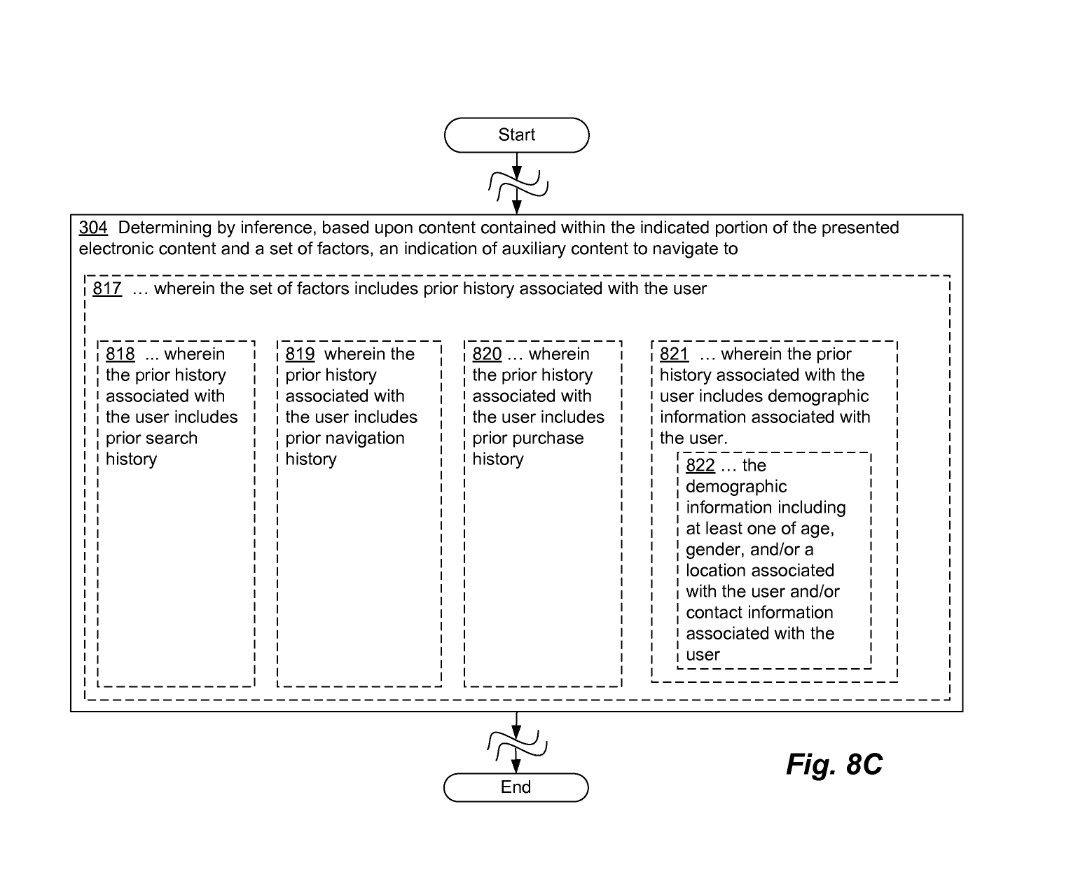

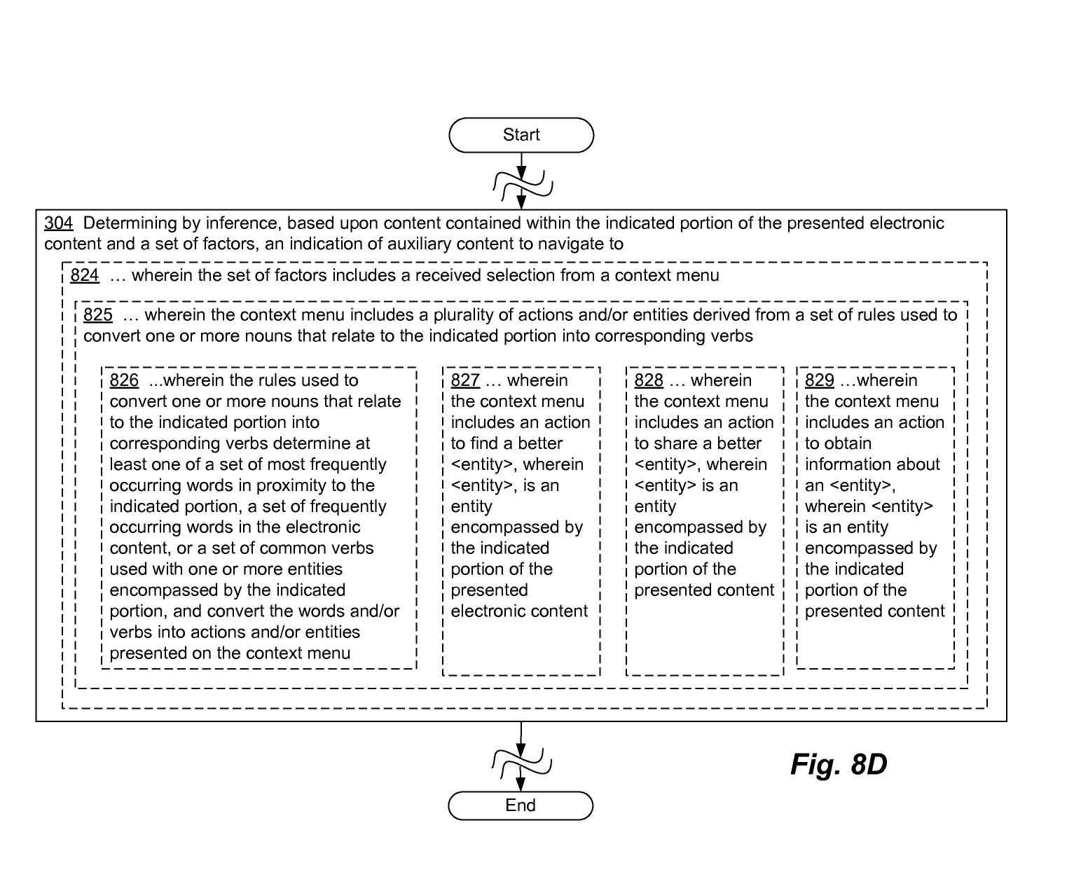

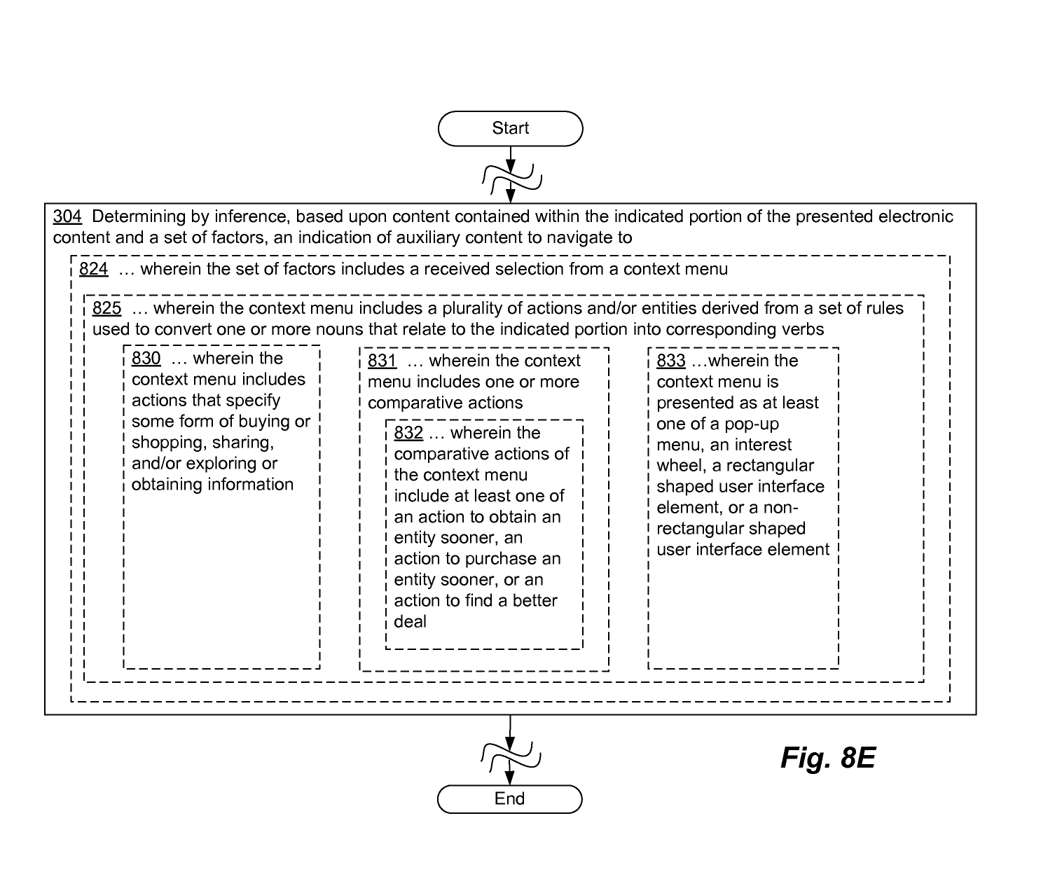

FIG. 8A is an example flow diagram of example logic illustrating various example embodiments of block 304 of FIG. 3. In some embodiments, the logic of operation 304 for determining by inference, based upon content contained within the indicated portion of the presented electronic content and a set of factors, an indication of auxiliary content to navigate to may include an operation 802 whose logic specifies that the set of factors includes context of other text, audio, graphics, and/or objects within the presented electronic content. The logic of operation 802 may be performed, for example, by the current context determination module 231 provided by the a factor determination module 113 of the GBNS 110 described with reference to FIGS. 2A and 2C to determine (e.g., retrieve, designate, resolve, etc.) context related information from the currently presented content, including other text, audio, graphics, and/or objects.

In some embodiments, operation 802 may further comprise an operation 803 whose logic specifies the set of factors includes an attribute of the gesture. The logic of operation 803 may be performed, for example, by the gesture attributes determination module 239 provided by the a factor determination module 113 of the GBNS 110 as described with reference to FIGS. 2A and 2C to determine context related information from the attributes of the gesture itself (e.g., color, size, direction, shape, and so forth).

In some embodiments, operation 803 may further include operation 804 whose logic specifies the attribute of the gesture is the size of the gesture. The logic of operation 804 may be performed, for example, by the gesture attributes determination module 239 provided by the a factor determination module 113 of the GBNS 110 as described with reference to FIGS. 2A and 2C to determine context related information from the attributes of the gesture such as size. Size of the gesture may include, for example, width and/or length, and other measurements appropriate to the input device 20*.

In the same or different embodiments operation 803 may include an operation 805 whose logic specifies the attribute of the gesture is a direction of the gesture. The logic of operation 804 may be performed, for example, by the gesture attributes determination module 239 provided by the a factor determination module 113 of the GBNS 110 as described with reference to FIGS. 2A and 2C to determine context related information from the attributes of the gesture such as direction. Direction of the gesture may include, for example, up or down, east or west, and other measurements or commands appropriate to the input device 20*.

In the same or different embodiments operation 803 may include an operation 806 whose logic specifies the attribute of the gesture is a color. The logic of operation 806 may be performed, for example, by the gesture attributes determination module 239 provided by the a factor determination module 113 of the GBNS 110 as described with reference to FIGS. 2A and 2C to determine context related information from the attributes of the gesture such as color. Color of the gesture may include, for example, a pen and/or ink color as well as other measurements appropriate to the input device 20*.

In the same or different embodiments operation 803 may include an operation 807 whose logic specifies the attribute of the gesture is a measure of steering of the gesture. The logic of operation 807 may be performed, for example by the gesture attributes determination module 239 provided by the a factor determination module 113 of the GBNS 110 as described with reference to FIGS. 2A and 2C to determine context related information from the attributes of the gesture such as steering. Steering of the gesture may occur when, for example, an initial gesture is indicated (e.g., on a mobile device) and the user desires to correct or nudge it in a certain direction.

In some embodiments operation 807 may further include an operation 808 whose logic specifies the steering of the gesture is accomplished by smudging the input device. The logic of operation 807 may be performed, for example, by the gesture attributes determination module 239 provided by the a factor determination module 113 of the GBNS 110 as described with reference to FIGS. 2A and 2C to determine context related information from the attributes of the gesture such as smudging. Smudging of the gesture may occur when, for example, an initial gesture is indicated (e.g., on a mobile device) and the user desires to correct or nudge it in a certain direction by, for example “smudging” the gesture using for example, a finger. This type of action may be particularly useful on a touch screen input device.

In the same or different embodiments operation 807 may include an operation 809 whose logic specifies the steering of the gesture is performed by a handheld gaming accessory. The logic of operation 807 may be performed, for example, by the gesture attributes determination module 239 provided by the a factor determination module 113 of the GBNS 110 as described with reference to FIGS. 2A and 2C to determine context related information from the attributes of the gesture such as steering. In this case the steering is performed by a handheld gaming accessory such as a particular type of input device 20*. For example, the gaming accessory may include a joy stick, a handheld controller, or the like.

In the same or different embodiments operation 807 may include an operation 810 whose logic specifies the steering of the gesture is a measure of adjustment of the gesture. The logic of operation 810 may be performed, for example, by the of the GBNS 110 as described with reference to FIGS. 2A and 2C. For example, by the gesture attributes determination module 239 provided by the a factor determination module 113 of the GBNS 110 as described with reference to FIGS. 2A and 2C. Once a gesture has been made, it may be adjusted (e.g., modified, extended, smeared, smudged, redone) by any mechanism, including, for example, adjusting the gesture itself, or, for example, by modifying what the gesture indicates, for example, using a context menu, selecting a portion of the indicated gesture, and so forth.

FIG. 8B is an example flow diagram of example logic illustrating various example embodiments of block 304 of FIG. 3. In some embodiments, the logic of operation 304 for determining by inference, based upon content contained within the indicated portion of the presented electronic content and a set of factors, an indication of auxiliary content to navigate to may include an operation 811 whose logic specifies the set of factors are associated with weights that are taken into consideration in determining the indication of auxiliary input to navigate to. The logic of operation 811 may be performed, for example, by the a factor determination module 113 of the GBNS 110 described with reference to FIGS. 2A and 2C. For example, in some embodiments, the attributes of the gesture may be more important, hence weighted more heavily, than other attributes, such as the prior navigation history of the user. Any form of weighting, whether explicit or implicit may be used.

In some embodiments, operation 304 may further include an operation 812 whose logic specifies the set of factors includes presentation device capabilities. The logic of operation 812 may be performed, for example, by the system attributes determination module 237 provided by the a factor determination module 113 of the GBNS 110 as described with reference to FIGS. 2A and 2C. Presentation device capabilities may include, for example, whether the device is connected to speakers or a network such as the Internet, the size, whether the device supports color, is a touch screen, and so forth.

In some embodiments, operation 812 may further include operation 813 whose logic specifies the presentation device capabilities includes the size of the presentation device. The logic of operation 813 may be performed, for example, by the system attributes determination module 237 provided by the a factor determination module 113 of the GBNS 110 as described with reference to FIGS. 2A and 2C. Presentation device capabilities may include, for example, whether the device is connected to speakers or a network such as the Internet, the size of the device, whether the device supports color, is a touch screen, and so forth.

In the same or different embodiments operation 812 may include an operation 814 whose logic specifies the presentation device capabilities includes whether text or audio is being presented. The logic of operation 814 may be performed, for example, by the system attributes determination module 237 provided by the a factor determination module 113 of the GBNS 110 as described with reference to FIGS. 2A and 2C. In addition to determining whether text or audio is being presented, presentation device capabilities may include, for example, whether the device is connected to speakers or a network such as the Internet, the size of the device, whether the device supports color, is a touch screen, and so forth.

In the same or different embodiments operation 304 may include an operation 815 whose logic specifies the set of factors includes prior device communication history. The logic of operation 815 may be performed, for example, by the system attributes determination module 237 provided by the a factor determination module 113 of the GBNS 110 as described with reference to FIGS. 2A and 2C. Prior device communication history may include aspects such as how often the computing system running the GPSS 110 has been connected to the Internet, whether multiple client devices are connected to it—some times, at all times, etc., and how often the computing system is connected with various remote search capabilities.

In the same or different embodiments operation 304 may include an operation 816 whose logic specifies the set of factors includes time of day. The logic of operation 816 may be performed, for example, by the system attributes determination module 237 provided by the a factor determination module 113 of the GBNS 110 as described with reference to FIGS. 2A and 2C to determine the time of day.

FIG. 8C is an example flow diagram of example logic illustrating various example embodiments of block 304 of FIG. 3. In some embodiments, the logic of operation 304 for determining by inference, based upon content contained within the indicated portion of the presented electronic content and a set of factors, an indication of auxiliary content to navigate to may include an operation 817 whose logic specifies the set of factors includes prior history associated with the user. The logic of operation 817 may be performed, for example, by prior history determination module 232 provided by the a factor determination module 113 of the GBNS 110 described with reference to FIGS. 2A and 2C to determine prior history that may be associated with (e.g., coincident with, related to, appropriate to, etc.) the user, for example, prior purchase, navigation, or search history or demographic information.

In some embodiments, operation 817 may further include an operation 818 whose logic specifies the prior history associated with the user includes prior search history. The logic of operation 818 may be performed, for example, by the search history determination module 235 provided by the prior history determination module 232 of the a factor determination module 113 of the GBNS 110 as described with reference to FIGS. 2A and 2C to determine a set of properties based upon the prior search history associated with the user. Factors such as what content the user has reviewed and looked for may be considered. Other factors may be considered as well.

In the same or different embodiments, operation 817 may include operation 819 whose logic specifies the prior history associated with the user includes prior navigation history. The logic of operation 819 may be performed, for example, by the navigation history determination module 236 provided by the prior history determination module 232 of the a factor determination module 113 of the GBNS 110 as described with reference to FIGS. 2A and 2C to determine a set of criteria based upon the prior navigation history associated with the user. Factors such as what content the user has reviewed, for how long, and where the user has navigated to from that point may be considered. Other factors may be considered as well.

In the same or different embodiments, operation 817 may include operation 820 whose logic specifies the prior history associated with the user includes prior purchase history. The logic of operation 820 may be performed, for example, by the prior purchase history determination module 234 of the a factor determination module 113 of the GBNS 110 as described with reference to FIGS. 2A and 2C to determine a set of factors based upon the prior purchase history associated with the user. Factors such as what products and/or services the user has bought or considered buying (determined, for example, by what the user has viewed) may be considered. Other factors may be considered as well.

In the same or different embodiments, operation 817 may include operation 821 whose logic specifies the prior history associated with the user includes demographic information associated with the user. The logic of operation 821 may be performed, for example, by the demographic history determination module 233 provided by the a factor determination module 113 of the GBNS 110 as described with reference to FIGS. 2A and 2C to determine a set of criteria based upon the demographic history associated with the user. Factors such as what the age, gender, location, citizenship, religious preferences (if specified) may be considered. Other factors may be considered as well.

In the some embodiments, operation 821 may further include operation 822 whose logic specifies the demographic information including at least one of age, gender, and/or a location associated with the user and/or contact information associated with the user. The logic of operation 822 may be performed, for example, by the demographic history determination module 233 provided by the a factor determination module 113 of the GBNS 110 as described with reference to FIGS. 2A and 2C to determine a set of criteria based upon the demographic history associated with the user including age, gender, or a location such as the user's residence information, country of citizenship, native language country, and the like.

FIG. 8D is an example flow diagram of example logic illustrating various example embodiments of block 304 of FIG. 3. In some embodiments, the logic of operation 304 for determining by inference, based upon content contained within the indicated portion of the presented electronic content and a set of factors, an indication of auxiliary content to navigate to may include an operation 824 whose logic specifies that the set of factors includes a received selection from a context menu. The logic of operation 824 may be performed, for example, by input handler 214 provided by the context menu handling module 211 of the GBNS 110 described with reference to FIGS. 2A and 2D. As explained elsewhere, a context menu may be used, for example, to adjust or modify a gesture, to modify indicated content contained within the portion indicated by the gesture, to add information to disambiguate input, control an inference, or the like. Anything that can be indicated by a menu could be used as a factor to influence the determination of auxiliary input. A context menu includes, for example, any type of menu that can be presented and relates to some context. For example, a context menu may include pop-up menus, dialog boxes, pull-down menus, interest wheels, or any other shape of menu, rectangular or otherwise.

In some embodiments, operation 824 may further include an operation 825 whose logic specifies that the context menu includes a plurality of actions and/or entities derived from a set of rules used to convert one or more nouns that relate to the indicated portion into corresponding verbs. The logic of operation 825 may be performed, for example, by the items determination module 212 provided by the context menu handling module 211 of the GBNS 110 described with reference to FIGS. 2A and 2D. The set of rules may include heuristics for developing verbs (actions) from nouns (entities) encompassed by the content by the gestured input, using for example, verification, frequency calculations, or other techniques.

In some embodiments, operation 825 may further include an operation 826 whose logic specifies the rules used to convert one or more nouns that relate to the indicated portion into corresponding verbs determine at least one of a set of most frequently occurring words in proximity to the indicated portion, a set of frequently occurring words in the electronic content, or a set of common verbs used with one or more entities encompassed by the indicated portion, and convert the words and/or verbs into actions and/or entities presented on the context menu. The logic of operation 826 may be performed, for example, by the items determination module 212 provided by the context menu handling module 211 of the GBNS 110 described with reference to FIGS. 2A and 2D. For example, the most frequent “n” occurring words in the presented electronic content may be counted and converted into verbs (actions), the “n” occurring words in proximity to the indicated portion (portion 25) of the presented electronic content may be used and/or converted into verbs (actions), the most common words in relative to some designated body of content may be used and/or converted into verbs (actions) and presented on the menu.

In the same or different embodiments, operation 825 may include operation 827 whose logic specifies the context menu includes at least one of an action to find a better <entity> wherein <entity> is an entity encompassed by the indicated portion of the presented electronic content. The logic of operation 827 may be performed, for example, by the items determination module 212 of the context menu handling module 211 of the GBNS 110 described with reference to FIGS. 2A and 2D. Rules for determining what is “better” may be context dependent such as, for example, brighter color, better quality photograph, more often purchased, or the like. Different heuristics may be programmed into the logic to thus derive a better entity.

In the same or different embodiments, operation 825 may include operation 828 whose logic specifies wherein the context menu includes an action to share an <entity>, wherein <entity> is an entity encompassed by the indicated portion of the presented electronic content. The logic of operation 828 may be performed, for example, by the items determination module 212 of the context menu handling module 211 of the GBNS 110 described with reference to FIGS. 2A and 2D. Sharing (e.g., forwarding, emailing, posting, messaging, communicating, or the like) may be also enhanced by context determined by the indicated portion (portion 25) or the set of criteria (e.g., prior search or purchase history, type of gesture, or the like).

In the same or different embodiments, operation 825 may include operation 829 whose logic specifies the context menu includes an action to obtain information about an <entity>, wherein <entity> is an entity encompassed by the indicated portion of the presented electronic content. The logic of operation 829 may be performed, for example, by the items determination module 212 of the context menu handling module 211 of the GBNS 110 described with reference to FIGS. 2A and 2D. Obtaining information may suggest actions like “find more information,” “get details,” “find source,” “define,” or the like.

FIG. 8E is an example flow diagram of example logic illustrating various example embodiments of block 825 of FIG. 8C. In some embodiments, the logic of operation 825 for the context menu includes a plurality of actions and/or entities derived from a set of rules used to convert one or more nouns that relate to the indicated portion into corresponding verbs may include an operation 830 whose logic specifies the context menu includes actions that specify some form of buying or shopping, sharing, and/or exploring or obtaining information. The logic of operation 830 may be performed, for example, by the items determination module 212 of the context menu handling module 211 of the GBNS 110 described with reference to FIGS. 2A and 2D. For example, actions for “buy <entity,” “obtain more info on <entity,” or the like may be derived by this logic.

In the same or different embodiments, operation 825 may include an operation 831 whose logic specifies the context menu includes one or more comparative actions. The logic of operation 831 may be performed, for example, by the items determination module 212 of the context menu handling module 211 of the GBNS 110 described with reference to FIGS. 2A and 2D. For example, comparative actions may include verb phrases such as “find me a better,” “find me a cheaper,” “ship me sooner,” or the like.

In some embodiments, operation 831 may further include an operation 832 whose logic specifies the comparative actions of the context menu include at least one of an action to obtain an entity sooner, an action to purchase an entity sooner, or an action to find a better deal. The logic of operation 832 may be performed, for example, by the items determination module 212 of the context menu handling module 211 of the GBNS 110 described with reference to FIGS. 2A and 2D. For example, obtain an entity sooner may include shipping sooner, subscribing faster, finishing quicker, or the like.

In the same or different embodiments, operation 825 may include an operation 833 whose logic specifies the context menu is presented as at least one of a pop-up menu, an interest wheel, a rectangular shaped user interface element, or a non-rectangular shaped user interface element. The logic of operation 833 may be performed, for example, by the a viewer module 216 provided by the context menu handling module 211 of the GBNS 110 as described with reference to FIGS. 2A and 2D. Pop-up menus may be implemented, for example, using overlay windows, dialog boxes, and the like, and appear visible with a standard user interface typically from the point of a “cursor,” “pointer,” or other reference associated with the gesture. Drop-down context menus may contain, for example, any number of actions and/or entities that are determined to be menu items. They appear visible with a standard user interface typically from the point of a “cursor,” “pointer,” or other reference associated with the gesture. In one embodiment, an interest wheel has menu items arranged in a pie shape. Rectangular menus may include pop-ups and pull-downs, although they may also be implemented in a non-rectangular fashion. Non-rectangular menus may include pop-ups, pull-downs, and interest wheels. They may also include other viewer controls.

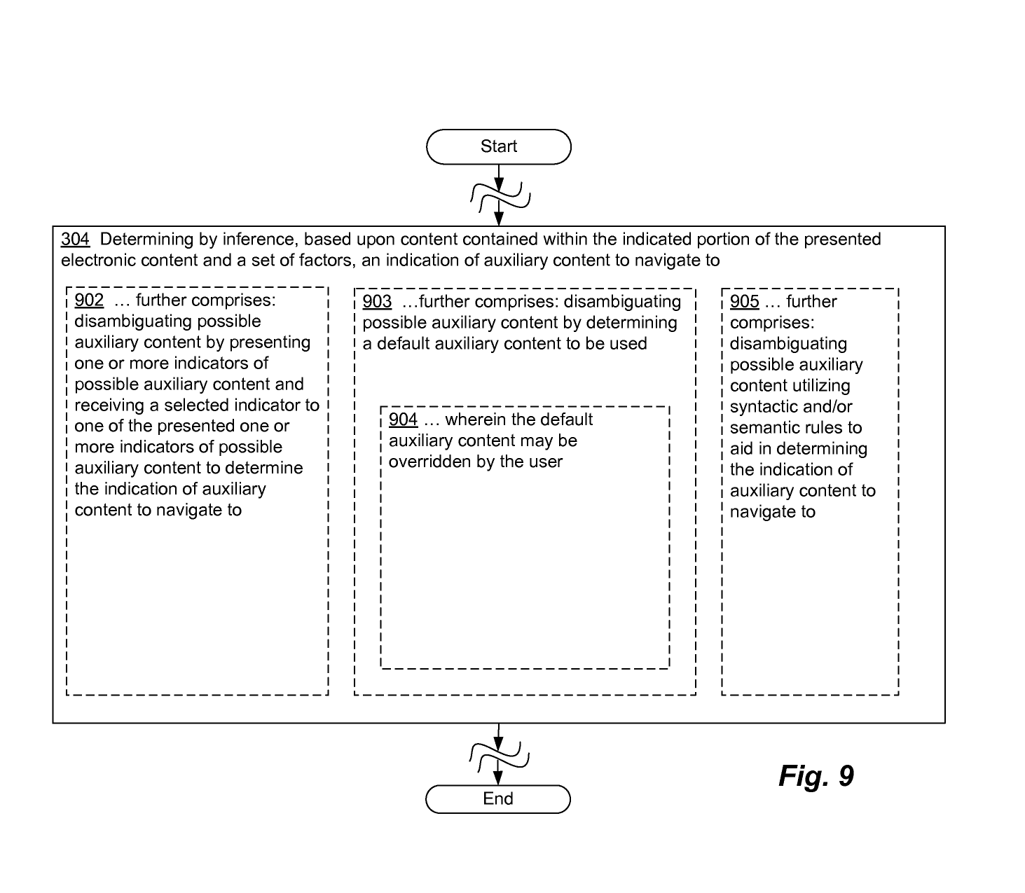

FIG. 9 is an example flow diagram of example logic illustrating various example embodiments of block 304 of FIG. 3. In some embodiments, the logic of operation 304 for determining by inference, based upon content contained within the indicated portion of the presented electronic content and a set of factors, an indication of auxiliary content to navigate to may include an operation 902 whose logic specifies disambiguating possible auxiliary content by presenting one or more indicators of possible auxiliary content and receiving a selected indicator to one of the presented one or more indicators of possible auxiliary content to determine the indication of auxiliary content to navigate to. The logic of operation 902 may be performed, for example, by of the disambiguation module 123 provided by the auxiliary content determination module 112 of the GBNS 110 as described with reference to FIGS. 2A and 2E. Presenting the one or more indicators of possible auxiliary content allows a user 10* to select which next content to navigate to, especially in the case where there is some sort of ambiguity.

In some embodiments, operation 304 may further include an operation 903 whose logic specifies disambiguating possible auxiliary content by determining a default auxiliary content to be used. The logic of operation 903 may be performed, for example, by the disambiguation module 123 provided by the auxiliary content determination module 112 of the GBNS 110 as described with reference to FIGS. 2A and 2E. The GBNS 110 may determine a default auxiliary content to navigate to (e.g., a web page concerning the most prominent entity in the indicated portion of the presented content) in the case of an ambiguous finding of auxiliary content.

In some embodiments, operation 903 may further include an operation 904 whose logic specifies the default auxiliary content may be overridden by the user. The logic of operation 904 may be performed, for example, by the disambiguation module 123 provided by the auxiliary content determination module 112 of the GBNS 110 as described with reference to FIGS. 2A and 2E. The DGGS 110 allows the user 10* to override an default auxiliary content presented in a variety of ways, including by specifying that no default content is to be presented. Overriding can take place as a configuration parameter of the system, upon the presentation of a set of possible selections of auxiliary content, or at other times.

In the same or different embodiments, operation 304 may include an operation 905 whose logic specifies disambiguating possible auxiliary content utilizing syntactic and/or semantic rules to aid in determining the indication of auxiliary content to navigate to. The logic of operation 905 may be performed, for example, by the disambiguation module 123 provided by the auxiliary content determination module 112 of the GBNS 110 as described with reference to FIGS. 2A and 2E. As described elsewhere, NLP-based mechanisms may be employed to determine what a user means by a gesture and hence what auxiliary content may be meaningful.

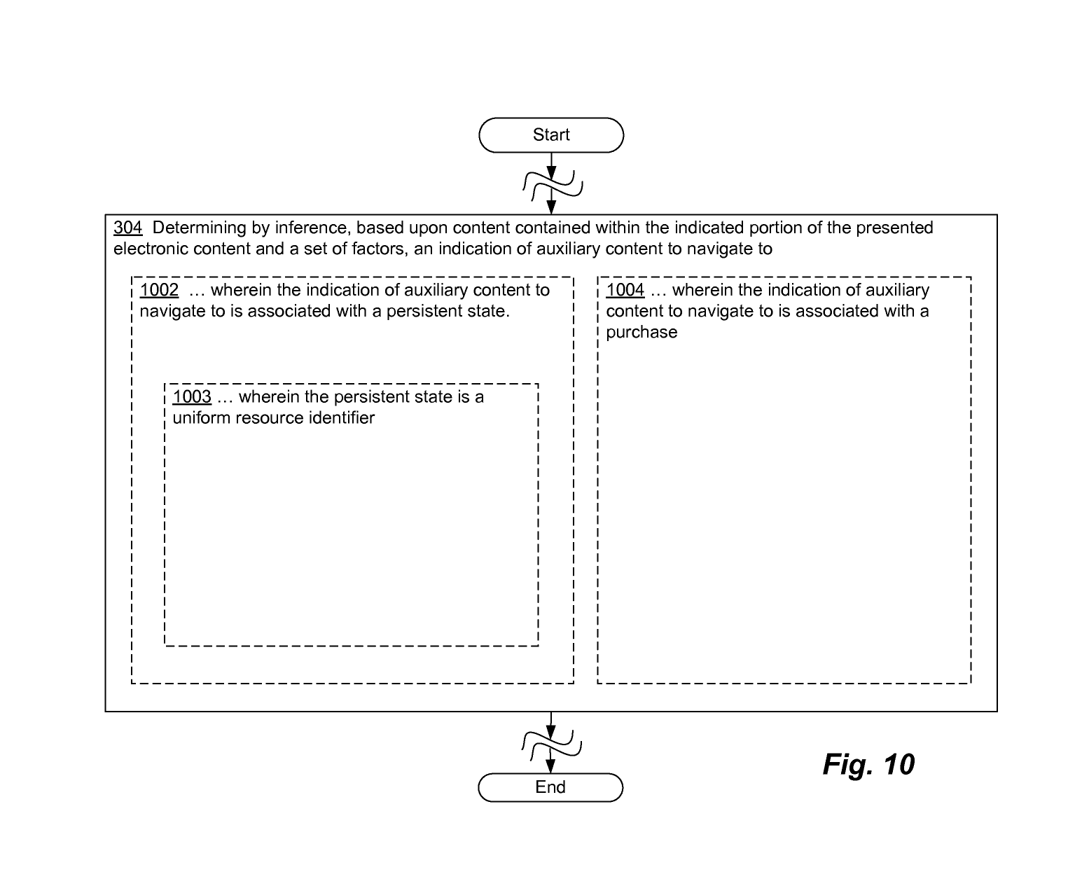

FIG. 10 is an example flow diagram of example logic illustrating various example embodiments of block 304 of FIG. 3. In some embodiments, the logic of operation 304 for determining by inference, based upon content contained within the indicated portion of the presented electronic content and a set of factors, an indication of auxiliary content to navigate to may include an operation 1002 whose logic specifies wherein the indication of auxiliary content to navigate to is associated with a persistent state. The logic of operation 1002 may be performed, for example, by the auxiliary content determination module 112 of the GBNS 110 as described with reference to FIGS. 2A and 2E by generating a representation of the auxiliary content in memory (e.g., memory 101 in FIG. 24), including a file, a link, or the like.

In some embodiments, operation 1002 may further include an operation 1003 whose logic specifies the persistent state is a uniform resource identifier. The logic of operation 1003 may be performed, for example, by the auxiliary content determination module 112 of the GBNS 110 as described with reference to FIGS. 2A and 2E by generating a representation of the auxiliary content as a uniform resource identifier (URI, or uniform resource locator, URL) that represents the auxiliary content.

In the same or different embodiments, operation 304 may include an operation 1004 whose logic specifies the indication of auxiliary content to navigate to is associated with a purchase. The logic of operation 1004 may be performed, for example, by the auxiliary content determination module 112 of the GBNS 110 as described with reference to FIGS. 2A and 2E to associate (e.g., link to or with, indicate, etc.) the auxiliary content with a user's purchase. The purchase may be obtainable from the prior purchase information identifiable by the purchase history determination module 234 of the prior history determination module 232 of the a factor determination module 113 of the GBNS 110.

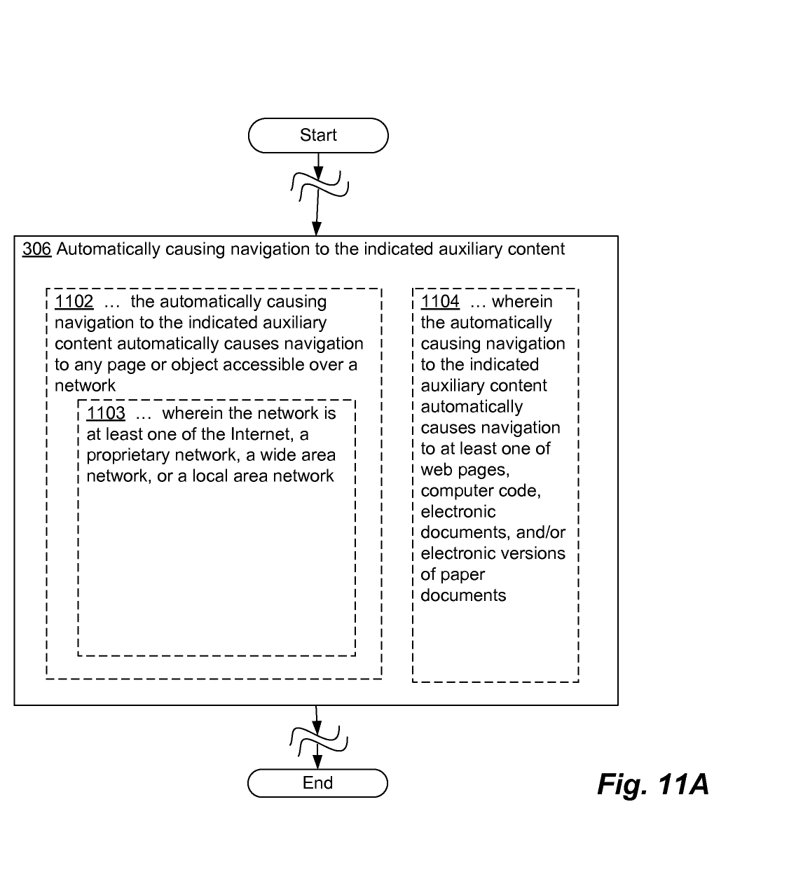

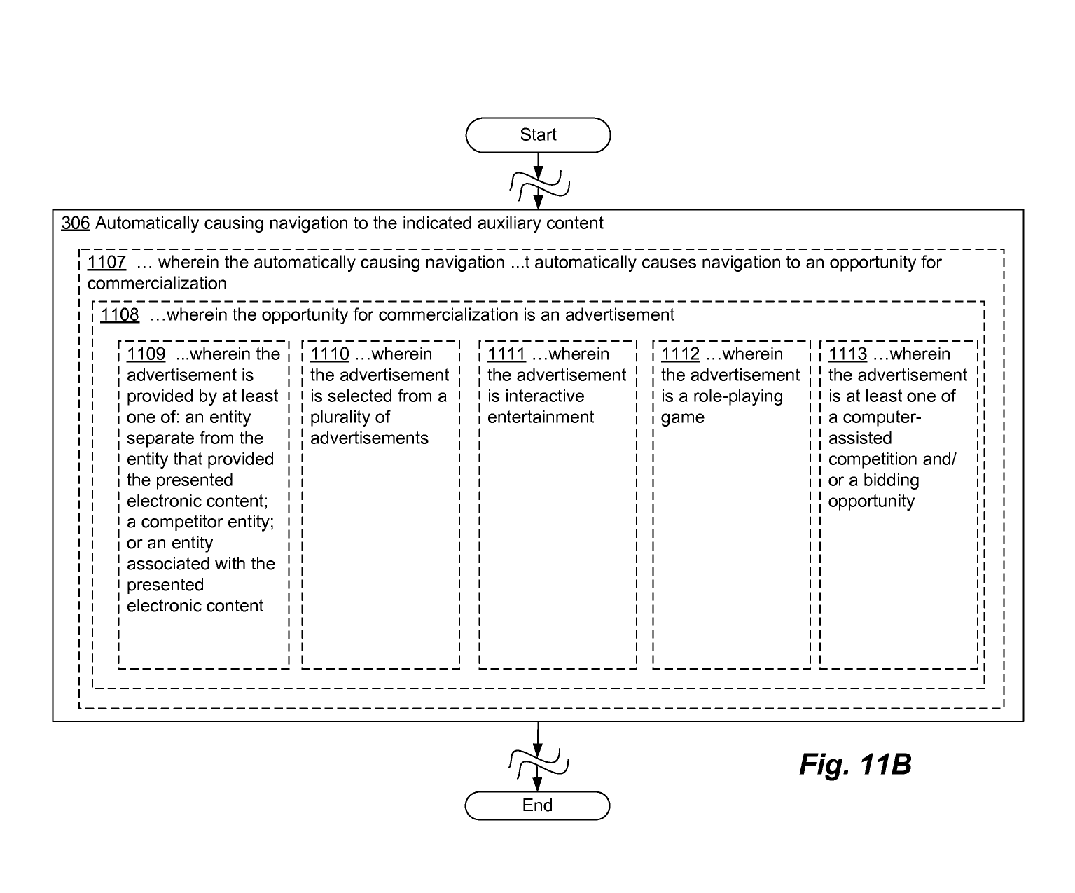

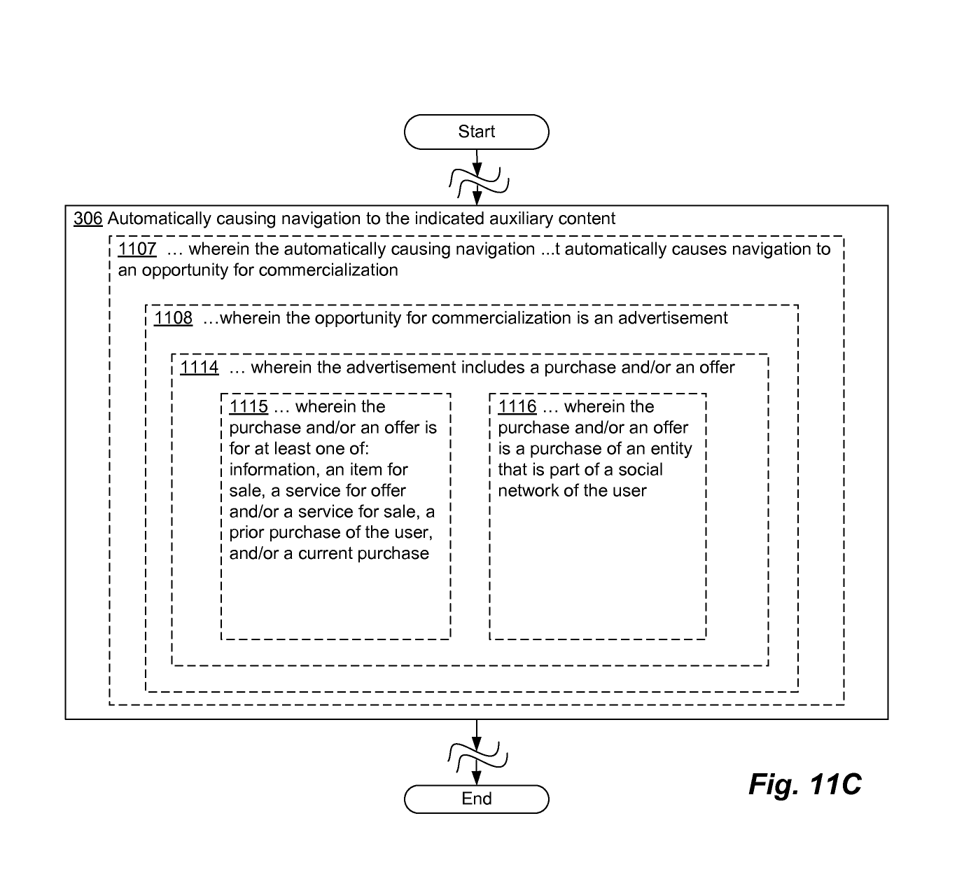

FIG. 11A is an example flow diagram of example logic illustrating various example embodiments of block 306 of FIG. 3. In some embodiments, the logic of operation 306 for automatically causing navigation to the indicated auxiliary content may include an operation 1102 whose logic specifies wherein the automatically causing navigation to the indicated auxiliary content automatically causes navigation to any page or object accessible over a network. The logic of operation 1102 may be performed, for example, by the automated navigation module 114 of the GBNS 110 described with reference to FIG. 2A. The navigation may be performed by any appropriate navigation technique as described elsewhere including a local or remote code connected via the network to the GBNS 110.

In some embodiments, operation 1102 may further include an operation 1103 whose logic specifies the network is at least one of the Internet, a proprietary network, a wide area network, or a local area network. The logic of operation 1103 may be performed, for example, by automated navigation module 114 of the GBNS 110 described with reference to FIG. 2A.

In the same or different embodiments, operation 306 may include an operation 1104 whose logic specifies the automatically causing navigation to the indicated auxiliary content automatically causes navigation to at least one of web pages, computer code, electronic documents, and/or electronic versions of paper documents. The logic of operation 1104 may be performed, for example, by the automated navigation module 114 of the GBNS 110 described with reference to FIG. 2A.

FIG. 11B is an example flow diagram of example logic illustrating various example embodiments of block 306 of FIG. 3. In some embodiments, the logic of operation 306 for automatically causing navigation to the indicated auxiliary content may include an operation 1107 whose logic specifies the automatically causing navigation to the indicated auxiliary content automatically causes navigation to an opportunity for commercialization. The logic of operation 1107 may be performed, for example, by the automated navigation module 114 of the GBNS 110 in conjunction with the advertisement determination module 202 provided by the opportunity for commercialization determination module 208 of the auxiliary content determination module 112 described with reference to FIGS. 2A and 2E. The opportunity for commercialization may involve any sort of content that gives the user or the system an opportunity for something to be purchased or offered for purchase or for any other sort of reason (e.g., survey, statistics, etc.) involving commerce. In this case the auxiliary content includes an indication of something that can be used for commercialization such as an advertisement, a web site that sells products, a bidding opportunity, a certificate, products, services, or the like.

In the some embodiments, operation 1107 may further include an operation 1108 whose logic specifies the opportunity for commercialization is an advertisement. The logic of operation 1106 may be performed, for example, by the advertisement determination module 202 provided by the opportunity for commercialization determination module 208 of the auxiliary content determination module 112 of the GBNS 110 described with reference to FIG. 2A. The advertisement may be provided by a remote tool connected via the network to the GBNS 110 such as an advertising system or server.

In the same or different embodiments, operation 1108 may include an operation 1109 whose logic specifies wherein the advertisement is provided by at least one of: an entity separate from the entity that provided the presented electronic content; a competitor entity; or an entity associated with the presented electronic content. The logic of operation 1109 may be performed, for example, by the advertisement determination module 202 provided by the opportunity for commercialization determination module 208 provided by the auxiliary content determination module 112 of the GBNS 110 described with reference to FIGS. 2A and 2E. The entity associated with the presented electronic content may be, for example, GBNS 110 and the advertisement from the auxiliary content 40. Advertisements may be supplied directly or indirectly as indicators to advertisements that can be served by server computing systems. The entity separate from the entity that provide the presented electronic content may be, for example, a third party or a competitor entity whose content is accessible through third party auxiliary content 43.

In some embodiments, operation 1108 may further include an operation 1110 whose logic specifies that the advertisement is selected from a plurality of advertisements. The logic of operation 1110 may be performed, for example, by the advertisement determination module 202 provided by the opportunity for commercialization determination module 208 provided by the auxiliary content determination module 112 of the GBNS 110 described with reference to FIGS. 2A and 2E. The advertisement may be a direct or indirect indication of an advertisement that is somehow supplemental to the content indicated by the indicated portion of the gesture. When a third party server, such as a third party advertising system, is used to supply the auxiliary content a plurality of advertisements may be delivered (e.g., forwarded, sent, communicated, etc.) to the GBNS 110 before being presented by the GBNS 110.

In some embodiments, operation 1108 may further include an operation 1111 whose logic specifies that the advertisement is interactive entertainment. The logic of operation 1111 may be performed, for example, by the advertisement determination module 202 provided by the opportunity for commercialization determination module 208 provided by the auxiliary content determination module 112 of the GBNS 110 described with reference to FIGS. 2A and 2E. The interactive entertainment may include, for example, a computer game, an on-line quiz show, a lottery, a movie to watch, and so forth.

In the same or different embodiments, operation 1108 may include an operation 1112 whose logic specifies that the advertisement is a role-playing game. The logic of operation 1112 may be performed, for example, by the advertisement determination module 202 provided by the opportunity for commercialization determination module 208 provided by the auxiliary content determination module 112 of the GBNS 110 described with reference to FIGS. 2A and 2E. A role-playing game may include, for example, an online multi-player role playing game.

In the same or different embodiments, operation 1108 may include an operation 1113 whose logic specifies that the advertisement is at least one of a computer-assisted competition and/or a bidding opportunity. The logic of operation 1113 may be performed, for example, by the bidding determination module 206 and/or the computer assisted competition determination module 205 provided by the opportunity for commercialization determination module 208 provided by the auxiliary content determination module 112 of the GBNS 110 described with reference to FIGS. 2A and 2E. The bidding opportunity, for example, a competition or gambling event, etc., may be computer based, computer-assisted, and/or manual.

FIG. 11C is an example flow diagram of example logic illustrating various example embodiments of block 1108 of FIG. 11B. In some embodiments, the logic of operation 1108 for the opportunity for commercialization is an advertisement includes an operation 1114 whose logic specifies that the advertisement includes a purchase and/or an offer. The logic of operation 1114 may be performed, for example, by the purchase and/or offer determination module 207 provided by the opportunity for commercialization determination module 208 provided by the auxiliary content determination module 112 of the GBNS 110 described with reference to FIGS. 2A and 2E. The purchase or offer may take any form, for example, a book advertisement, or a web page, and may be for products and/or services.

In the same or different embodiments, operation 1108 may include an operation 1115 whose logic specifies that the purchase and/or an offer is for at least one of: information, an item for sale, a service for offer and/or a service for sale, a prior purchase of the user, and/or a current purchase. The logic of operation 1115 may be performed, for example, by the purchase and/or offer determination module 207 provided by the opportunity for commercialization determination module 208 provided by the auxiliary content determination module 112 of the GBNS 110 described with reference to FIGS. 2A and 2E. Any type of information, item, or service (online or offline, machine generated or human generated) can be offered and/or purchased in this manner. If human generated the advertisement may be to a computer representation of the human generated service, for example, a contract or a calendar entry, or the like.

In some embodiments, operation 1114 may further include an operation 1116 whose logic specifies that the purchase and/or an offer is a purchase of an entity that is part of a social network of the user. The logic of operation 1116 may be performed, for example, by the purchase and/or offer determination module 207 provided by the opportunity for commercialization determination module 208 provided by the auxiliary content determination module 112 of the automated navigation module 114 of the GBNS 110 described with reference to FIGS. 2A and 2E. The purchase may be related to (e.g., associated with, directed to, mentioned by, a contact directly or indirectly related to, etc.) someone that belongs to a social network associated with the user, for example through the one or more networks 30.

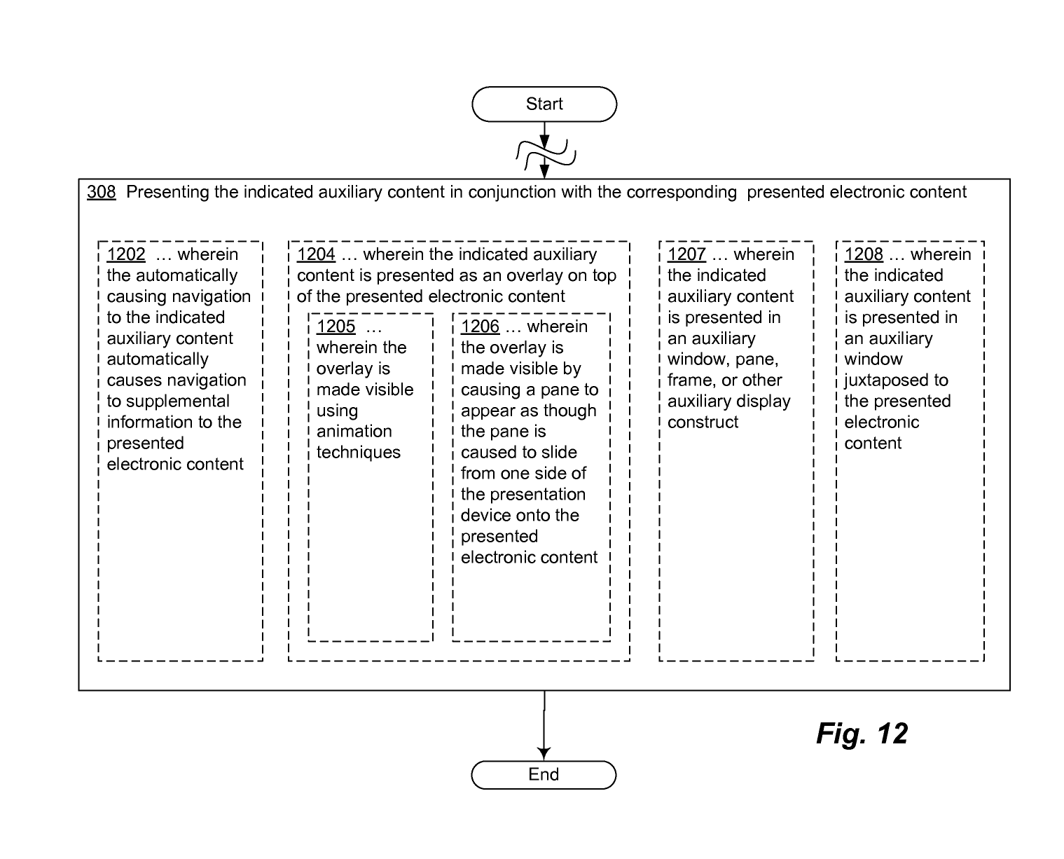

FIG. 12 is an example flow diagram of example logic illustrating various example embodiments of block 308 of FIG. 3. In some embodiments, the logic of operation 308 for causing the indicated auxiliary content to be presented in conjunction with the corresponding presented electronic content may include an operation 1202 whose logic specifies wherein the automatically causing navigation to the indicated auxiliary content automatically causes navigation to supplemental information to the presented electronic content. The logic of operation 1202 may be performed, for example, by the supplemental content determination module 204 provided by the auxiliary content determination module 112 of the GBNS 110 described with reference to FIGS. 2A and 2E. The supplemental information may be of any nature, for example, an additional document or portion thereof, map, web page, advertisement, and so forth.

In the same or different embodiments, operation 308 may include an operation 1204 whose logic specifies that the indicated auxiliary content presented as an overlay on top of the presented electronic content. The logic of operation 1204 may be performed, for example, by the overlay presentation module 252 provided by the presentation module 115 of the GBNS 110 as described with reference to FIGS. 2A and 2F. The overlay may be in any form including a pane, window, menu, dialog, frame, etc. and may partially or totally obscure the underlying presented content.

In some embodiments, operation 1204 may further include an operation 1205 whose logic specifies that the overlay is made visible using animation techniques. The logic of operation 1205 may be performed, for example, by the animation module 254 in conjunction with the overlay presentation module 252 provided by the presentation module 115 of the GBNS 110 as described with reference to FIGS. 2A and 2F. The animation techniques may include leaving trailing foot print information for the user to see the animation, may be of varying speeds, involve different shapes, sounds, or the like.

In the same or different embodiments, operation 1204 may further include an operation 1206 whose logic specifies that the overlay is made visible by causing a pane to appear as though the pane is caused to slide from one side of the presentation device onto the presented electronic content. The logic of operation 1206 may be performed, for example, by the animation module 254 in conjunction with the overlay presentation module 252 provided by the presentation module 115 of the GBNS 110 as described with reference to FIGS. 2A and 2F. The pane may be a window, frame, popup, dialog box, or any other presentation construct that may be made gradually more visible as it is moved into the visible presentation area. Once there, the pane may obscure, not obscure, or partially obscure the other presented content.

In the same or different embodiments, operation 308 may include an operation 1207 whose logic specifies that the indicated auxiliary content is presented in an auxiliary window, pane, frame, or other auxiliary display construct. The logic of operation 1207 may be performed, for example, by the auxiliary display generation module 256 provided by the presentation module 115 of the GBNS 110 as described with reference to FIGS. 2A and 2F. Once generated, the auxiliary display module may be presented in an animated fashion, overlaid upon other content, placed non-contiguously or juxtaposed to other content.

In the same or different embodiments, operation 308 may include an operation 1208 whose logic specifies that the indicated auxiliary content is presented in an auxiliary window juxtaposed to the presented electronic content. The logic of operation 1208 may be performed, for example, by the auxiliary display generation module 256 provided by the presentation module 115 of the GBNS 110 as described with reference to FIGS. 2A and 2F. For example, the auxiliary content may be presented in a separate window or frame to enable the user to see the original content alongside the auxiliary content (such as an advertisement).

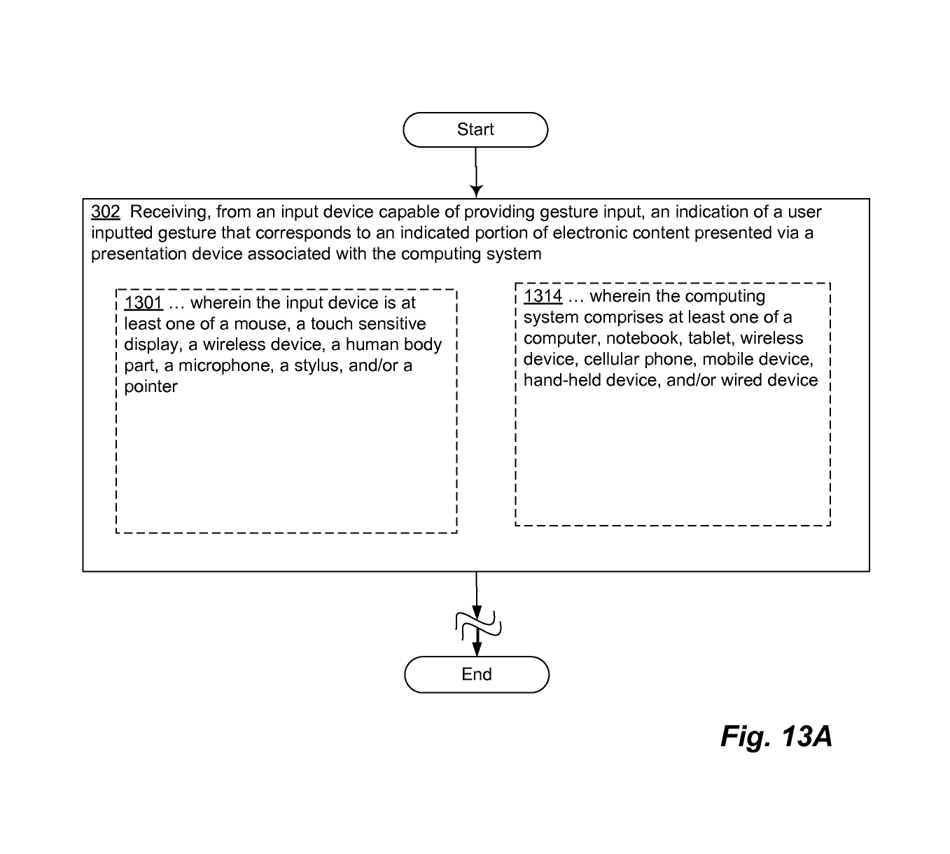

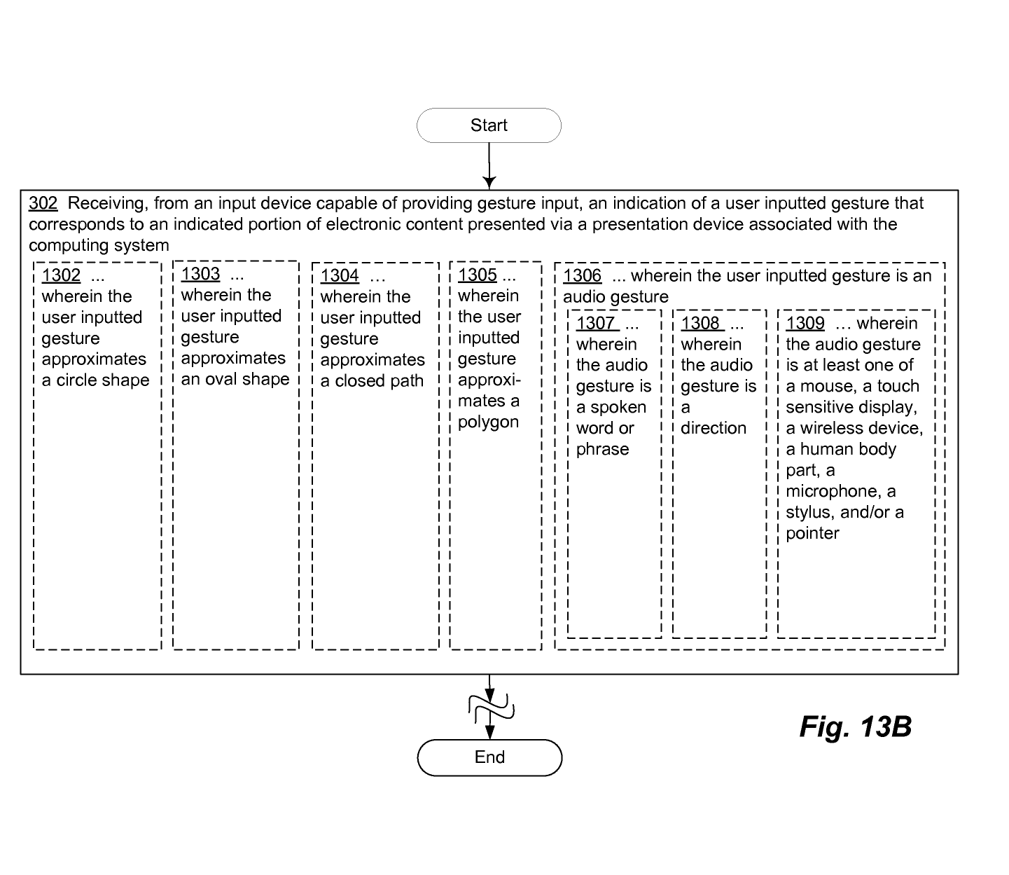

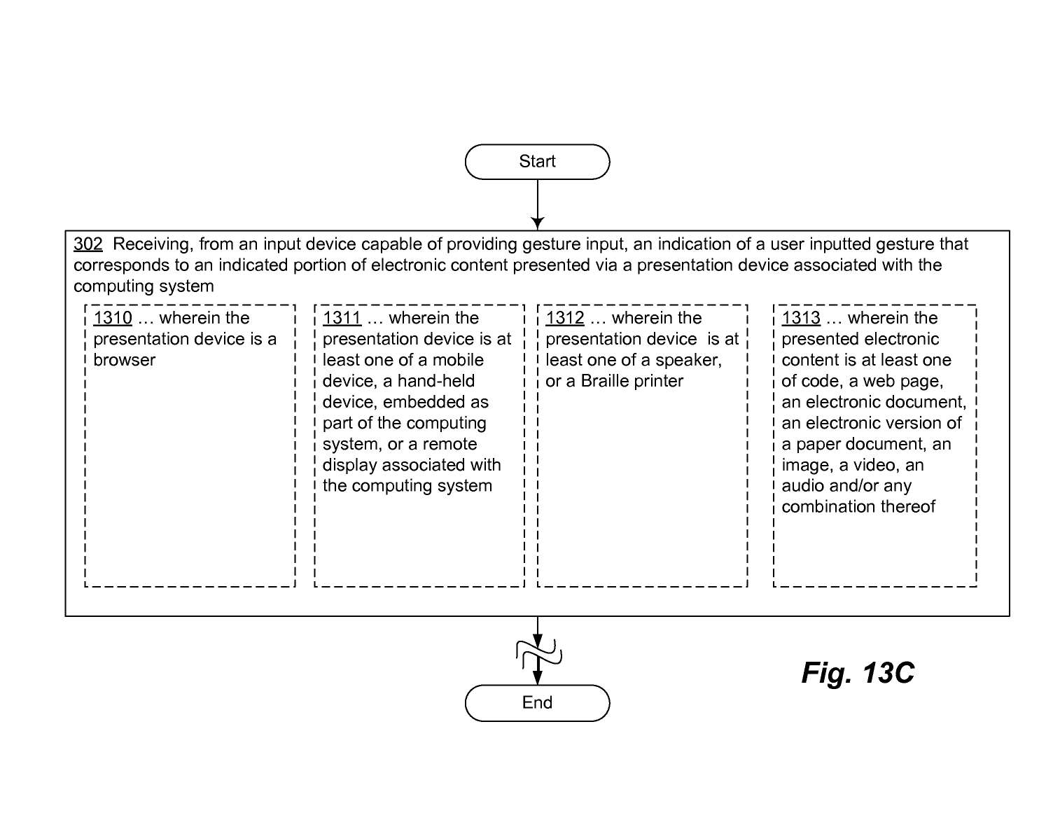

FIG. 13A is an example flow diagram of example logic illustrating various example embodiments of block 302 of FIG. 3. In some embodiments, the logic of operation 302 for receiving, from an input device capable of providing gesture input, an indication of a user inputted gesture that corresponds to an indicated portion of electronic content presented via a presentation device associated with the computing system may include an operation 1301 whose logic specifies wherein the input device is at least one of a mouse, a touch sensitive display, a wireless device, a human body part, a microphone, a stylus, and/or a pointer. The logic of operation 1301 may be performed, for example, by the specific device handlers 125 provided by the input module 111 of the GBNS 110 as described with reference to FIGS. 2A and 2B to detect and resolve gesture input from, for example, devices 20*.

In the same or different embodiments, operation 302 comprises an operation 1314 whose logic specifies that the computing system comprises at least one of a computer, notebook, tablet, wireless device, cellular phone, mobile device, hand-held device, and/or wired device. The logic of operation 1314 may be performed, for example, by the computing system 100 as described with reference to FIGS. 2A.

FIG. 13B is an example flow diagram of example logic illustrating various example embodiments of block 302 of FIG. 3. In some embodiments, the logic of operation 302 for receiving, from an input device capable of providing gesture input, an indication of a user inputted gesture that corresponds to an indicated portion of electronic content presented via a presentation device associated with the computing system may include an operation 1302 whose logic specifies wherein the user inputted gesture approximates a circle shape. The logic of operation 1302 may be performed, for example, by the specific device handlers 125 provided by the input module 111 of the GBNS 110 as described with reference to FIGS. 2A and 2B to detect whether a received gesture is in a form that approximates a circle shape.

In the same or different embodiments, operation 302 may include an operation 1303 whose logic specifies that the user inputted gesture approximates an oval shape. The logic of operation 1303 may be performed, for example, by the specific device handlers 125 provided by the input module 111 of the GBNS 110 as described with reference to FIGS. 2A and 2B to detect whether a received gesture is in a form that approximates an oval shape.

In the same or different embodiments, operation 302 may include an operation 1304 whose logic specifies that the user inputted gesture approximates a closed path. The logic of operation 1304 may be performed, for example, by the specific device handlers 125 provided by the input module 111 of the GBNS 110 as described with reference to FIGS. 2A and 2B to detect whether a received gesture is in a form that approximates a closed path of points and/or line segments.

In the same or different embodiments, operation 302 may include an operation 1305 whose logic specifies that the user inputted gesture approximates a polygon. The logic of operation 1305 may be performed, for example, by the specific device handlers 125 provided by the input module 111 of the GBNS 110 as described with reference to FIGS. 2A and 2B to detect whether a received gesture is in a form that approximates a polygon.

In the same or different embodiments, operation 302 may include an operation 1306 whose logic specifies that the user inputted gesture is an audio gesture. The logic of operation 1306 may be performed, for example, by the specific device handlers 125 provided by the input module 111 of the GBNS 110 as described with reference to FIGS. 2A and 2B to detect whether a received gesture is an audio gesture, such as received via audio device, microphone 20b.

In the some embodiments, operation 1306 may further include an operation 1307 whose logic specifies that the audio gesture is a spoken word or phrase. The logic of operation 1307 may be performed, for example, by the audio handling module 222 provided by the gesture input detection and resolution module 121 in conjunction with the specific device handlers 125 provided by the input module 111 of the GBNS 110 as described with reference to FIGS. 2A and 2B to detect whether a received audio gesture, such as received via audio device, microphone 20b, indicates (e.g., designates or otherwise selects) a word or phrase indicating some portion of the presented content.

In the same or different embodiments, operation 1306 may include an operation 1308 whose logic specifies that the audio gesture is a direction. The logic of operation 1308 may be performed, for example, by the audio handling module 222 provided by the gesture input detection and resolution module 121 in conjunction with the specific device handlers 125 provided by the input module 111 of the GBNS 110 as described with reference to FIGS. 2A and 2B to detect a direction received from an audio input device, such as audio input device 20b. The direction may be a single letter, number, word, phrase, or any type of instruction or indication of where to move a cursor or locator device.

In the same or different embodiments, operation 1306 may include an operation 1309 whose logic specifies that the audio gesture is at least one of a mouse, a touch sensitive display, a wireless device, a human body part, a microphone, a stylus, and/or a pointer. The logic of operation 1309 may be performed, for example, by the audio handling module 222 provided by the gesture input detection and resolution module 121 in conjunction with the specific device handlers 125 provided by the input module 111 of the GBNS 110 as described with reference to FIGS. 2A and 2B to detect and resolve audio gesture input from, for example, devices 20*.

FIG. 13C is an example flow diagram of example logic illustrating various example embodiments of block 302 of FIG. 3. In some embodiments, the logic of operation 302 for receiving, from an input device capable of providing gesture input, an indication of a user inputted gesture that corresponds to an indicated portion of electronic content presented via a presentation device associated with the computing system may include an operation 1310 whose logic specifies wherein the presentation device is a browser. The logic of operation 1310 may be performed, for example, by the specific device handlers 258 of the presentation module 115 of the GBNS 110 as described with reference to FIGS. 2A and 2F.

In the same or different embodiments, operation 302 may include an operation 1311 whose logic specifies that the presentation device is at least one of a mobile device, a hand-held device, embedded as part of the computing system, or a remote display associated with the computing system. The logic of operation 1311 may be performed, for example, by the specific device handlers 258 of the presentation module 115 of the GBNS 110 as described with reference to FIGS. 2A and 2F.

In the same or different embodiments, operation 302 may include an operation 1312 whose logic specifies that the presentation device is at least one of a speaker or a Braille printer. The logic of operation 1312 may be performed, for example, by the specific device handlers 258 of the presentation module 115 of the GBNS 110 as described with reference to FIGS. 2A and 2F.

In the same or different embodiments, operation 302 may include an operation 1313 whose logic specifies that the presented electronic contentis at least one of code, a web page, an electronic document, an electronic version of a paper document, an image, a video, an audio and/or any combination thereof. The logic of operation 1313 may be performed, for example, by one or more modules of the gesture input detection and resolution module 121 of the input module 111 of the GBNS 110 as described with reference to FIGS. 2A and 2B.

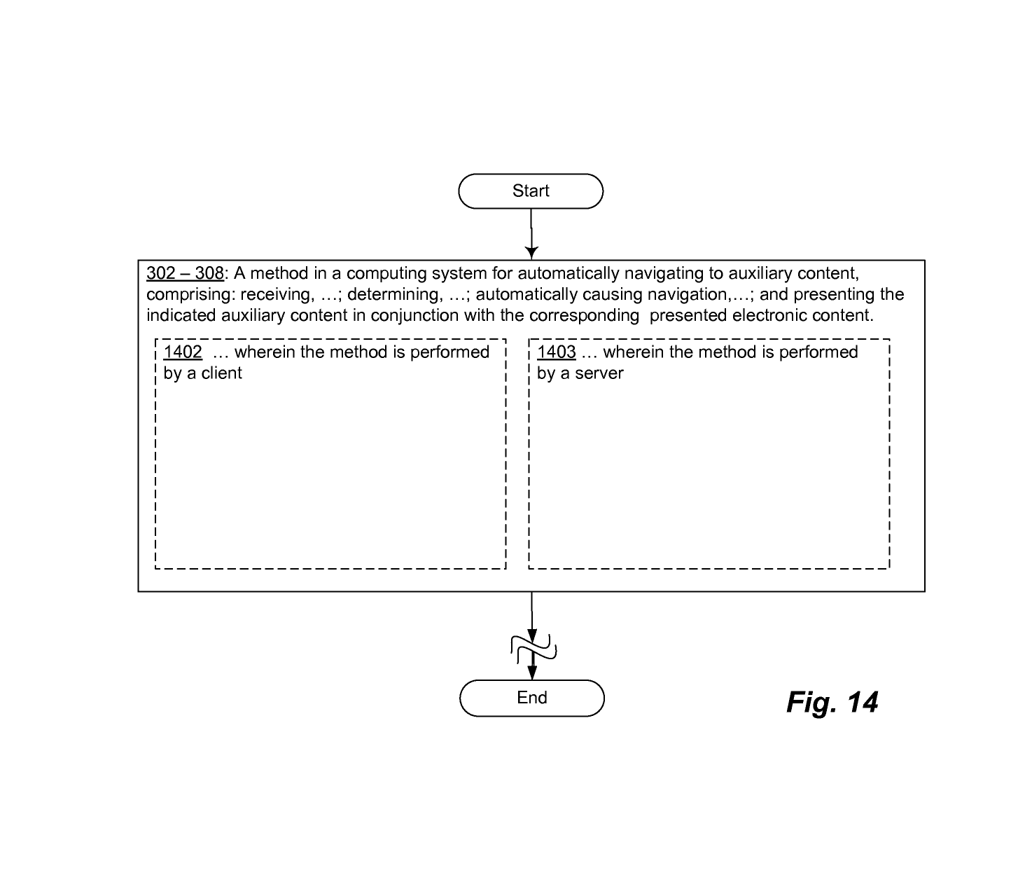

FIG. 14 is an example flow diagram of example logic illustrating various example embodiments of blocks 302 to 308 of FIG. 3. In particular, the logic of the operations 302 to 310 may further include logic 1402 that specifies that the entire method is performed by a client. As described earlier, a client may be hardware, software, or firmware, physical or virtual, and may be part or the whole of a computing system. A client may be an application or a device.

In the same or different embodiments, the logic of the operations 302 to 310 may further include logic 1403 that specifics that the entire method is performed by a server. As described earlier, a server may be hardware, software, or firmware, physical or virtual, and may be part or the whole of a computing system. A server may be service as well as a system.

FIG. 15 is an example block diagram of a computing system for practicing embodiments of a Gesture Based Navigation System as described herein. Note that a general purpose or a special purpose computing system suitably instructed may be used to implement an GBNS, such as GBNS 110 of FIG. 1D. Further, the GBNS may be implemented in software, hardware, firmware, or in some combination to achieve the capabilities described herein.

The computing system 100 may comprise one or more server and/or client computing systems and may span distributed locations. In addition, each block shown may represent one or more such blocks as appropriate to a specific embodiment or may be combined with other blocks. Moreover, the various blocks of the GBNS 110 may physically reside on one or more machines, which use standard (e.g., TCP/IP) or proprietary interprocess communication mechanisms to communicate with each other.

In the embodiment shown, computer system 100 comprises a computer memory (“memory”) 101, a display 1502, one or more Central Processing Units (“CPU”) 1503, Input/Output devices 1504 (e.g., keyboard, mouse, CRT or LCD display, etc.), other computer-readable media 1505, and one or more network connections 1506. The GBNS 110 is shown residing in memory 101. In other embodiments, some portion of the contents, some of, or all of the components of the GBNS 110 may be stored on and/or transmitted over the other computer-readable media 1505. The components of the GBNS 110 preferably execute on one or more CPUs 1503 and manage providing automatic navigation to auxiliary content, as described herein. Other code or programs 1530 and potentially other data stores, such as data repository 1520, also reside in the memory 101, and preferably execute on one or more CPUs 1503. Of note, one or more of the components in FIG. 15 may not be present in any specific implementation. For example, some embodiments embedded in other software may not provide means for user input or display.

In a typical embodiment, the GBNS 110 includes one or more input modules 111, one or more auxiliary content determination modules 112, one or more factor determination modules 113, one or more automated navigation modules 114, and one or more presentation modules 115. In at least some embodiments, some data is provided external to the GBNS 110 and is available, potentially, over one or more networks 30. Other and/or different modules may be implemented. In addition, the GBNS 110 may interact via a network 30 with application or client code 1555 that can absorb navigation results, for example, for other purposes, one or more client computing systems or client devices 20*, and/or one or more third-party content provider systems 1565, such as third party advertising systems or other purveyors of auxiliary content. Also, of note, the history data repository 1515 may be provided external to the GBNS 110 as well, for example in a knowledge base accessible over one or more networks 30.

In an example embodiment, components/modules of the GBNS 110 are implemented using standard programming techniques. However, a range of programming languages known in the art may be employed for implementing such example embodiments, including representative implementations of various programming language paradigms, including but not limited to, object-oriented (e.g., Java, C++, C#, Smalltalk, etc.), functional (e.g., ML, Lisp, Scheme, etc.), procedural (e.g., C, Pascal, Ada, Modula, etc.), scripting (e.g., Perl, Ruby, Python, JavaScript, VBScript, etc.), declarative (e.g., SQL, Prolog, etc.), etc.

The embodiments described above may also use well-known or proprietary synchronous or asynchronous client-server computing techniques. However, the various components may be implemented using more monolithic programming techniques as well, for example, as an executable running on a single CPU computer system, or alternately decomposed using a variety of structuring techniques known in the art, including but not limited to, multiprogramming, multithreading, client-server, or peer-to-peer, running on one or more computer systems each having one or more CPUs. Some embodiments are illustrated as executing concurrently and asynchronously and communicating using message passing techniques. Equivalent synchronous embodiments are also supported by an GBNS implementation.

In addition, programming interfaces to the data stored as part of the GBNS 110 (e.g., in the data repositories 1515 and 41) can be available by standard means such as through C, C++, C#, Visual Basic.NET and Java APIs; libraries for accessing files, databases, or other data repositories; through scripting languages such as XML; or through Web servers, FTP servers, or other types of servers providing access to stored data. The repositories 1515 and 41 may be implemented as one or more database systems, file systems, or any other method known in the art for storing such information, or any combination of the above, including implementation using distributed computing techniques.

Also the example GBNS 110 may be implemented in a distributed environment comprising multiple, even heterogeneous, computer systems and networks. Different configurations and locations of programs and data are contemplated for use with techniques of described herein. In addition, the server and/or client components may be physical or virtual computing systems and may reside on the same physical system. Also, one or more of the modules may themselves be distributed, pooled or otherwise grouped, such as for load balancing, reliability or security reasons. A variety of distributed computing techniques are appropriate for implementing the components of the illustrated embodiments in a distributed manner including but not limited to TCP/IP sockets, RPC, RMI, HTTP, Web Services (XML-RPC, JAX-RPC, SOAP, etc.) etc. Other variations are possible. Also, other functionality could be provided by each component/module, or existing functionality could be distributed amongst the components/modules in different ways, yet still achieve the functions of an GBNS.

Furthermore, in some embodiments, some or all of the components of the GBNS 110 may be implemented or provided in other manners, such as at least partially in firmware and/or hardware, including, but not limited to one or more application-specific integrated circuits (ASICs), standard integrated circuits, controllers executing appropriate instructions, and including microcontrollers and/or embedded controllers, field-programmable gate arrays (FPGAs), complex programmable logic devices (CPLDs), and the like. Some or all of the system components and/or data structures may also be stored as contents (e.g., as executable or other machine-readable software instructions or structured data) on a computer-readable medium (e.g., a hard disk; memory; network; other computer-readable medium; or other portable media article to be read by an appropriate drive or via an appropriate connection, such as a DVD or flash memory device) to enable the computer-readable medium to execute or otherwise use or provide the contents to perform at least some of the described techniques. Some or all of the components and/or data structures may be stored on tangible, non-transitory storage mediums. Some or all of the system components and data structures may also be stored as data signals (e.g., by being encoded as part of a carrier wave or included as part of an analog or digital propagated signal) on a variety of computer-readable transmission mediums, which are then transmitted, including across wireless-based and wired/cable-based mediums, and may take a variety of forms (e.g., as part of a single or multiplexed analog signal, or as multiple discrete digital packets or frames). Such computer program products may also take other forms in other embodiments. Accordingly, embodiments of this disclosure may be practiced with other computer system configurations.

All of the above U.S. patents, U.S. patent application publications, U.S. patent applications, foreign patents, foreign patent applications and non-patent publications referred to in this specification and/or listed in the Application Data Sheet, are incorporated herein by reference, in their entireties.

From the foregoing it will be appreciated that, although specific embodiments have been described herein for purposes of illustration, various modifications may be made without deviating from the spirit and scope of the claims. For example, the methods and systems for performing automatic navigation to auxiliary content discussed herein are applicable to other architectures other than a windowed or client-server architecture. Also, the methods and systems discussed herein are applicable to differing protocols, communication media (optical, wireless, cable, etc.) and devices (such as wireless handsets, electronic organizers, personal digital assistants, tablets, portable email machines, game machines, pagers, navigation devices such as GPS receivers, etc.).

1. A method in a computing system for automatically navigating to auxiliary content, comprising:
receiving, from an input device capable of providing gesture input, an indication of a user inputted gesture that corresponds to an indicated portion of electronic content presented via a presentation device associated with the computing system;
determining by inference, based upon content contained within the indicated portion of the presented electronic content and a set of factors, an indication of auxiliary content to navigate to;
automatically causing navigation to the indicated auxiliary content; and
causing the indicated auxiliary content to be presented in conjunction with the corresponding presented electronic content.

2. The method of claim 1 wherein the indication of auxiliary content to navigate to comprises at least one of a word, a phrase, an utterance, an image, a video, a pattern, or an audio signal.

3. The method of claim 1 wherein the indication of auxiliary content to navigate to comprises at least one of a location, a pointer, a symbol, and/or another type of reference.

4.-5. (canceled)

6. The method of claim 1 wherein the content contained within the indicated portion of electronic content includes an audio portion.

7. The method of claim 1 wherein the content contained within the indicated portion of electronic content includes at least a word or a phrase.

8. The method of claim 1 wherein the content contained within the indicated portion of electronic content includes at least a graphical object, image, and/or icon.

9. The method of claim 1 wherein the content contained within the indicated portion of electronic content includes an utterance.

10. The method of claim 1 wherein the content contained within the indicated portion of electronic content comprises non-contiguous parts or contiguous parts.

11. The method of claim 1 wherein the content contained within the indicated portion of electronic content is determined using syntactic and/or semantic rules.

12. The method of claim 1 wherein the set of factors are associated with weights that are taken into consideration in determining the indication of auxiliary input to navigate to.

13. The method of claim 1 wherein the set of factors includes an attribute of the gesture.

14. The method of claim 13 wherein the attribute of the gesture is at least one of a size of the gesture, a direction of the gesture, a color, and/or a measure of steering of the gesture.

15.-20. (canceled)

21. The method of claim 1 wherein the set of factors includes presentation device capabilities.

22.-23. (canceled)

24. The method of claim 1 wherein the set of factors includes at least one of prior device communication history, time of day, and/or prior history associated with the user.

25.-26. (canceled)

27. The method of claim 24 wherein the prior history associated with the user includes at least one of prior search history, prior navigation history, prior purchase history, and/or demographic information associated with the user.

28.-31. (canceled)

32. The method of claim 1 wherein the set of factors includes a received selection from a context menu.

33. The method of claim 32 wherein the context menu includes a plurality of actions and/or entities derived from a set of rules used to convert one or more nouns that relate to the indicated portion into corresponding verbs.

34. (canceled)

35. The method claim 32 wherein the context menu includes actions that specify some form of buying or shopping, sharing, and/or exploring or obtaining information.

36. The method of claim 32 wherein the context menu includes an action to find, to share, and/or to obtain information about a better <entity>, wherein <entity> is an entity encompassed by the indicated portion of the presented electronic content.

37.-38. (canceled)

39. The method of claim 33 wherein the context menu includes one or more comparative actions.

40. The method of claim 39 wherein the comparative actions of the context menu include at least one of an action to obtain an entity sooner, an action to purchase an entity sooner, or an action to find a better deal.

41. The method of claim 34 wherein the context menu is presented as at least one of a pop-up menu, an interest wheel, a rectangular shaped user interface element, or a non-rectangular shaped user interface element.

42. The method of claim 1 wherein the set of factors includes context of other text, audio, graphics, and/or objects within the presented electronic content.

43. The method of claim 1 wherein determining by inference, based upon content contained within the indicated portion of the presented electronic content and a set of factors, an indication of auxiliary content to navigate to further comprises:
disambiguating possible auxiliary content by presenting one or more indicators of possible auxiliary content and receiving a selected indicator to one of the presented one or more indicators of possible auxiliary content to determine the indication of auxiliary content to navigate to.

44.-45. (canceled)

46. The method of claim 1 wherein determining by inference, based upon content contained within the indicated portion of the presented electronic content and a set of factors, an indication of auxiliary content to navigate to further comprises:
disambiguating possible auxiliary content utilizing syntactic and/or semantic rules to aid in determining the indication of auxiliary content to navigate to.

47. The method of claim 1 wherein the indication of auxiliary content to navigate to is associated with a persistent state and/or a purchase.

48. The method of claim 47 wherein the persistent state is a uniform resource identifier.

49. (canceled)

50. The method of claim 1 wherein the automatically causing navigation to the indicated auxiliary content automatically causes navigation to any page or object accessible over a network.

51.-52. (canceled)

53. The method of claim 1 wherein the automatically causing navigation to the indicated auxiliary content automatically causes navigation to an opportunity for commercialization.

54. The method of claim 53 wherein the opportunity for commercialization is an advertisement.

55. The method of claim 54 wherein the advertisement is provided by at least one of: an entity separate from the entity that provided the presented electronic content; a competitor entity; or an entity associated with the presented electronic content.

56. The method of claim 54 wherein the advertisement is selected from a plurality of advertisements.

57. The method of claim 53 wherein the advertisement is at least one of interactive entertainment, a role-playing game, a computer-assisted competition and/or a bidding opportunity, and/or a purchase and/or an offer.

58.-60. (canceled)

61. The method of claim 60 wherein the purchase and/or an offer is for at least one of: information, an item for sale, a service for offer and/or a service for sale, a prior purchase of the user, and/or a current purchase.

62. The method of claim 60 wherein the purchase and/or an offer is a purchase of an entity that is part of a social network of the user.

63. The method of claim 1 wherein the automatically causing navigation to the indicated auxiliary content automatically causes navigation to supplemental information to the presented electronic content.

64. The method of claim 1 wherein the indicated auxiliary content presented as an overlay on top of the presented electronic content.

65. (canceled)

66. The method of claim 64 wherein the overlay is made visible by causing a pane to appear as though the pane is caused to slide from one side of the presentation device onto the presented electronic content.

67. The method of claim 1 wherein the indicated auxiliary content is presented in an auxiliary window, pane, frame, or other auxiliary display construct.

68. The method of claim 1 wherein the indicated auxiliary content is presented in an auxiliary window juxtaposed to the presented electronic content.

69. The method of claim 1 wherein the computing system comprises at least one of a computer, notebook, tablet, wireless device, cellular phone, mobile device, hand-held device, and/or wired device.

70. The method of claim 1 wherein the input device is at least one of a mouse, a touch sensitive display, a wireless device, a human body part, a microphone, a stylus, and/or a pointer.

71. The method of claim 1 wherein the user inputted gesture approximates at least one of a circle shape, an oval shape, a closed path, and/or a polygon.

72.-74. (canceled)

75. The method of claim 1 wherein the user inputted gesture is an audio gesture.

76.-79. (canceled)

80. The method of claim 1 wherein the presentation device is at least one of a browser, a mobile device, a hand-held device, embedded as part of the computing system, a remote display associated with the computing system, and/or a speaker or a Braille printer.

81. (canceled)

82. The method of claim 1 wherein the presented electronic content is at least one of code, a web page, an electronic document, an electronic version of a paper document, an image, a video, an audio and/or any combination thereof.

83. The method of claim 1 performed by a client or by a server.

84.-223. (canceled)
